(19) United States
(12) Patent Application Publication
(10) Pub. No.: US 2026/0150150 A1
(43) Pub. Date: May 28, 2026

(54) INDICATION AND UPDATE OF ULTRA HIGH RELIABILITY PARAMETERS BY A STA

(71) Applicant: Samsung Electronics Co., Ltd., Suwon-si (KR)

(72) Inventors: Vishnu Vardhan Ratnam, Frisco, TX (US); Bilal Sadiq, Plano, TX (US); Boon Loong Ng, Plano, TX (US); Rubayet Shafin, Frisco, TX (US); Peshal Nayak, Plano, TX (US); Yue Qi, Plano, TX (US)

(21) Appl. No.: 19/388,922

(22) Filed: Nov. 13, 2025

Related U.S. Application Data
(60) Provisional application No. 63/725,873, filed on Nov. 27, 2024.
(60) Provisional application No. 63/727,903, filed on Dec. 4, 2024.
(60) Provisional application No. 63/813,367, filed on May 28, 2025.
(60) Provisional application No. 63/828,796, filed on Jun. 23, 2025.
(60) Provisional application No. 63/848,733, filed on Jul. 22, 2025.
(60) Provisional application No. 63/853,049, filed on Jul. 29, 2025.

(51) Int. Cl. H04W 76/20; H04W 16/28; H04W 84/12; H04W 88/08

(52) U.S. Cl. CPC H04W 76/20; H04W 16/28; H04W 84/12; H04W 88/08

(57) ABSTRACT

Methods and apparatuses for indication and update of ultra high reliability (UHR) parameters by a station (STA) in a wireless communication system. A method of wireless communication performed by an electronic device includes generating an indication that indicates an ultra high reliability (UHR) mode; generating an indication that indicates an update to at least one parameter of the UHR mode; transmitting the indication that indicates the UHR mode to a receiving device; and transmitting the indication that indicates the update to the at least one parameter of the UHR mode to the receiving device.

### CROSS-REFERENCE TO RELATED APPLICATION(S) AND CLAIM OF PRIORITY

This application claims priority under 35 U.S.C. § 119(e) to U.S. Provisional Patent Application No. 63/725,873 , filed on Nov. 27, 2024, U.S. Provisional Patent Application No. 63/727,903, filed on Dec. 4, 2024, U.S. Provisional Patent Application No. 63/788,480, filed on Apr. 14, 2025, U.S. Provisional Patent Application No. 63/813,367 , filed on May 28, 2025, U.S. Provisional Patent Application No. 63/828,796 , filed on Jun. 23, 2025, U.S. Provisional Patent Application No. 63/848,733 , filed on Jul. 22, 2025, and U.S. Provisional Patent Application No. 63/853,049 , filed on Jul. 29, 2025, each of which are hereby incorporated by reference in its entirety.

### TECHNICAL FIELD

This disclosure relates generally to wireless communication, and more specifically to indication and update of ultra high reliability (UHR) parameters by a station (STA) in a wireless communication system.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for indication and update of UHR parameters by a STA in a wireless communication system.

In one embodiment, an electronic device comprises a transceiver; and a processor operably coupled to the transceiver. The processor is configured to: generate an indication that indicates an ultra high reliability (UHR) mode; and generate an indication that indicates an update to at least one parameter of the UHR mode. The transceiver is configured to: transmit the indication that indicates the UHR mode to a receiving device; and transmit the indication that indicates the update to the at least one parameter of the UHR mode to the receiving device.

In another embodiment, a method of wireless communication performed by an electronic device includes: generating an indication that indicates a UHR mode; generating an indication that indicates an update to at least one parameter of the UHR mode; transmitting the indication that indicates the UHR mode to a receiving device; and transmitting the indication that indicates the update to the at least one parameter of the UHR mode to the receiving device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of dynamic power save (DPS) operation at a DPS supporting STA according to embodiments of the present disclosure;

FIG. 5 illustrates an example of a DPS information element according to embodiments of the present disclosure;

FIG. 6 illustrates an example of the UHR auxiliary parameters frame according to embodiments of the present disclosure;

FIG. 7 illustrates an example of encoding of the update type subfield of the DPS information element/sub-element according to embodiments of the present disclosure;

FIG. 8 illustrates an example of DPS information within a UHR operation element according to embodiments of the present disclosure;

FIG. 9 illustrates another example of DPS information within a UHR operation element according to embodiments of the present disclosure;

FIG. 10 illustrates an example of a DPS static HCM field in the UHR operation parameters field of the UHR operation element according to embodiments of the present disclosure;

FIG. 11 illustrates an example of a DPS static HCM support field in the UHR MAC capabilities information field according to embodiments of the present disclosure;

FIG. 12 illustrates an example of DPS information in the reconfiguration multi-link element according to embodiments of the present disclosure;

FIG. 13 illustrates an example of indicating updates to multiple UHR operation modes in the reconfiguration multi-link element according to embodiments of the present disclosure;

FIG. 14 illustrates an example of the DPS parameter indication in a UHR Operation Mode Notification frame sent by a non-AP DPS STA according to embodiments of the present disclosure;

FIG. 15 illustrates an example of the format of the UHR mode change element according to embodiments of the present disclosure;

FIG. 16 illustrates an example of the DPS-variant UHR mode parameters field when the mode ID indicates DPS mode according to embodiments of the present disclosure;

FIG. 17 illustrates an example of the UHR BSS Parameter Change Count field and UHR Critical Update Flag indication in a Basic Multi-link element according to embodiments of the present disclosure;

FIG. 18 illustrates an example of the UHR Operation Mode Notification frame sent by an AP in response to the DPS parameter update notification received from a DPS non-AP STA according to embodiments of the present disclosure;

FIG. 19 illustrates an example of the DPS AP indicating the DPS operation parameters within the UHR Operation element according to embodiments of the present disclosure;

FIG. 20 illustrates an example method of the operations performed by a DPS STA to indicate DPS parameters according to embodiments of the present disclosure;

FIG. 21 illustrates an example method of the operations performed by a DPS supporting peer STA to receive updates about DPS parameters of a DPS STA according to embodiments of the present disclosure;

FIG. 22 illustrates an example where parameters of different UHR modes are indicated in the UHR Operations element according to embodiments of the present disclosure;

FIG. 23 illustrates another example where parameters of different UHR modes are indicated in the UHR Operations element according to embodiments of the present disclosure;

FIG. 24 illustrates an example where parameters of different UHR modes are indicated in the Reconfiguration multi-link element according to embodiments of the present disclosure;

FIG. 25 illustrates still another example where parameters of different UHR modes are indicated in a new element called the UHR Parameters Update element according to embodiments of the present disclosure;

FIG. 26 illustrates an example of UHR feature-specific updates carried in a common frame according to embodiments of the present disclosure;

FIG. 27 illustrates another example of UHR feature-specific updates carried in a common frame according to embodiments of the present disclosure;

FIG. 28 illustrates yet another example of UHR feature-specific updates carried in a common frame according to embodiments of the present disclosure; and

FIG. 29 illustrates a method performed by an electronic device in a wireless communication system according to embodiments of the present disclosure.

### DETAILED DESCRIPTION

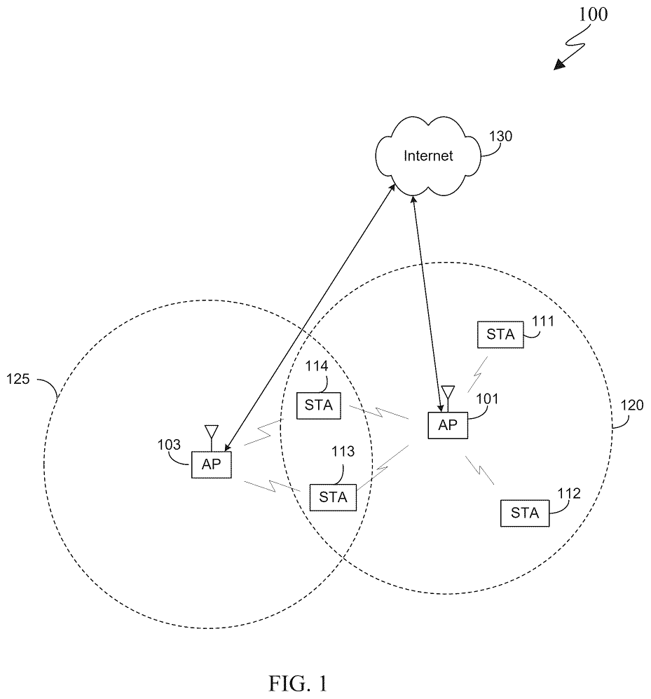

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification”; [2] IEEE P802.11ax/D8.0; [3] IEEE P802.11be/D5.0; [4] 11-23/1835r0—AP power management; [5] 11-23/225r0—Considering Unscheduled AP power save; [6]11-23/1965r0—Dynamic Power Save follow up.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating indication and update of UHR parameters by a STA in a wireless communication system. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

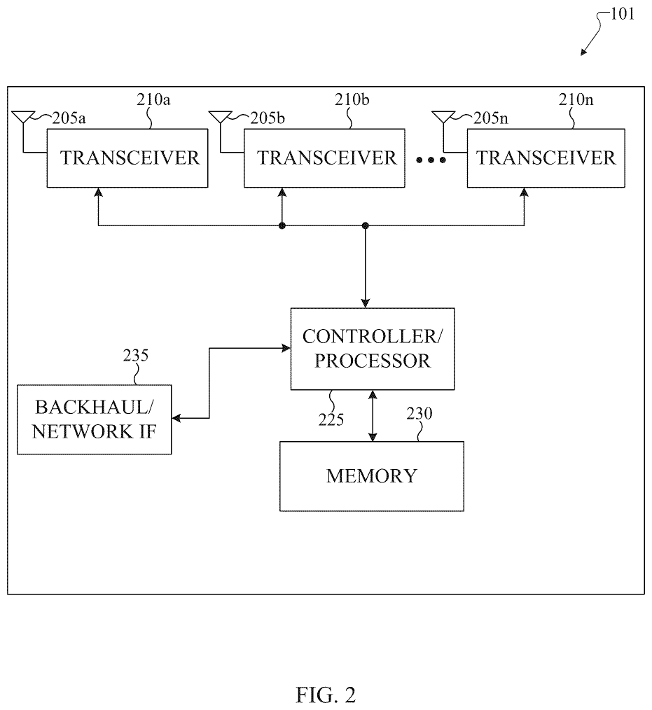

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating indication and update of UHR parameters by a STA in a wireless communication system. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating indication and update of UHR parameters by a STA in a wireless communication system. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

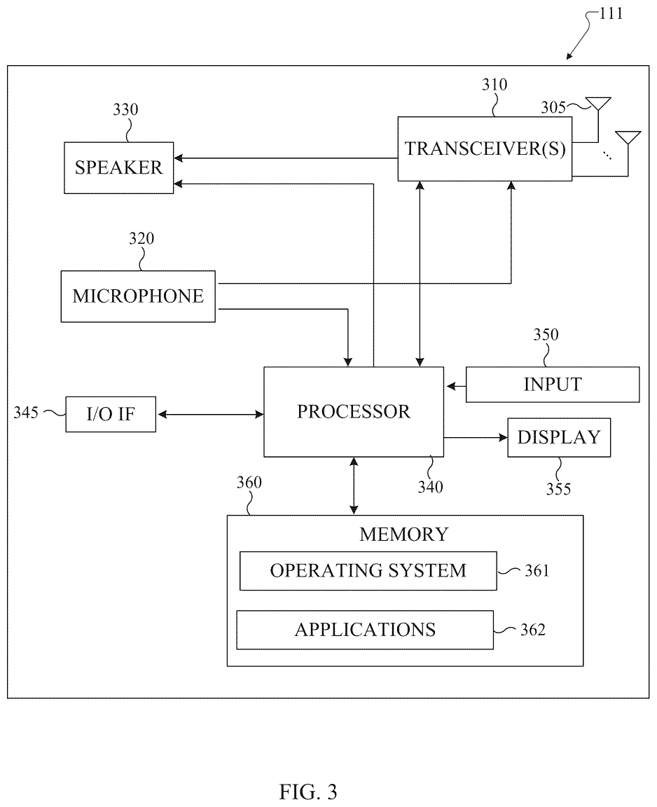

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate indication and update of UHR parameters by a STA in a wireless communication system. In some embodiments, the processor 340 includes at least one microprocessor or microcontroller.

The processor 340 is also capable of executing other processes and programs resident in the memory 360, such as operations for facilitating indication and update of UHR parameters by a STA in a wireless communication system. The processor 340 can move data into or out of the memory 360 as required by an executing process. In some embodiments, the processor 340 is configured to execute a plurality of applications 362, such as applications for facilitating indication and update of UHR parameters by a STA in a wireless communication system. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

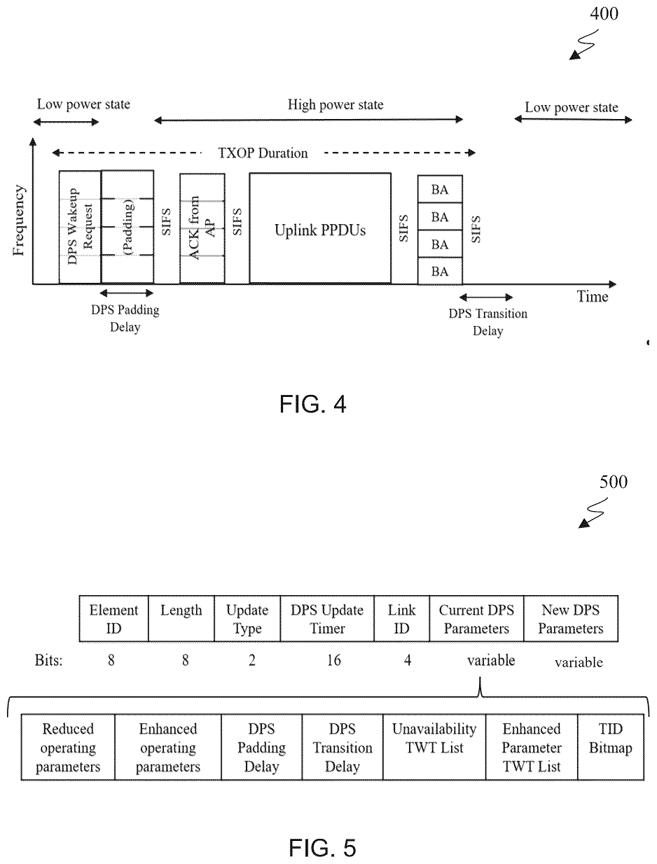

FIG. 4 illustrates an example of DPS operation at a DPS supporting STA 400 according to embodiments of the present disclosure. The embodiment of the example DPS operation at a DPR supporting STA 400 shown in FIG. 4 is for illustration only. Other embodiments of the example DPS operation at a DPS supporting STA 400 could be used without departing from the scope of this disclosure.

Embodiments of the present disclosure recognize that enabling power saving operation at an AP and a non-AP is a key requirement for the next generation of WiFi. A typical Wi-Fi device spends more than 80% of its awake time performing a listen operation, where it is neither transmitting nor receiving, but is sensing the medium for channel idleness or potential incoming traffic. Correspondingly reducing listen state power consumption provides significant energy savings both at a non-AP STA and also at an AP STA.

In order to save a STA's listen-state power consumption, and yet minimize the degradation in performance for latency sensitive traffic, DPS operation has been proposed [4-6]. For convenience a STA that has this feature enabled is referred to herein as a DPS STA. In DPS mode, by default the DPS STA may operate in a low power state with reduced capabilities, e.g., one or more of reduced supported channel width, reduced supported limited Physical Protocol Data Unit (PPDU) formats, reduced supported modulation and coding scheme (MCS) set and number of spatial streams (NSS) set, etc. Operating with these reduced capabilities may help the STA save power. These capabilities are referred to herein as the Reduced Operation Capabilities. However, upon receiving a request within a TXOP from a peer STA, the DPS STA can transition to high power state, wherein it increases one or more of its supported channel width (CW), supported PPDU formats, supported MCS set and NSS set for at least the duration of the TXOP. These capabilities are referred to herein as the Enhanced Operation Capabilities. Thus, after sending a request to the DPS STA to increase the capabilities, the peer STA can perform communication at the enhanced operating capabilities for the rest of the TXOP, with better spectral efficiency. After the end of the TXOP or after a predetermined amount of time from the end of the TXOP, the DPS STA may return to its low power state. An illustration of DPS operation at a STA is depicted in FIG. 4.

This DPS mechanism can be used by one or more of: a non-AP STA, a mobile AP STA, or an AP STA.

Embodiments of the present disclosure recognize that there are several DPS parameters pertaining to a Dynamic Power Save operation enabled by a DPS STA. One or more of these DPS parameters can also be changed over time. For any DPS STA (AP or non-AP), mechanisms to efficiently indicate the aforementioned DPS parameters may be required to ensure that when changes to the DPS mode or its parameters are made, all relevant peer STAs should be aware of the changes in a timely manner. If the DPS STA is an AP, additional mechanisms to efficiently indicate the DPS parameters may be required to ensure that any new STA or unassociated STAs and APs in other BSSs can receive the DPS information in a timely manner.

Accordingly, embodiments of the present disclosure provide mechanisms for a STA that is supporting a DPS feature to efficiently indicate the DPS specific parameters to other STAs. Some of these mechanisms may also be used for efficient indication of the parameters corresponding to other UHR features, e.g., Non-primary Channel Access, Dynamic Sub-band Operation, Dynamic Bandwidth Expansion (DBE), Co-existence support, Periodic Unavailability Operation (PUO), Dynamic Unavailability Operation (DUO), Limited Operation Mode (LOM), etc.

Although some embodiments in this disclosure focus on DPS-related parameters, similar indication mechanisms may also be used for parameter indication and parameter update indication corresponding to other operating modes. Examples of such other operating modes may include: Non-primary Channel Access (NPCA) operation, Dynamic Sub-band Operation (DSO), Dynamic Bandwidth Expansion (DBE), Co-existence support, Periodic Unavailability Operation (PUO), Dynamic Unavailability Operation (DUO), Limited Operation Mode (LOM), etc. In these cases, although the operating parameters themselves may be different from the ones described in this disclosure, the indication method, and some associated parameters, e.g., Update Type, Update Timer, etc., may be applicable.

Similarly, although some embodiments discussed in this disclosure may suggest adding new fields to signal some indications, the shown fields should be interpreted as examples and not as a limitation on the indications themselves. In some other examples, these described indications can be carried in alternative fields or elements as well.

In some embodiments, DPS parameters that define the DPS operation by a DPS STA may include one or more of:
DPS Mode: An indication of whether the DPS mode is enabled or disabled by the DPS STA.
Reduced Operating Parameters: Supported operating parameters (BW, MCS, NSS, PPDU format) in the low power state.
Enhanced Operating Parameters: Supported operating parameters (BW, MCS, NSS, PPDU format) in the high power state.
DPS Padding Delay: The time required by the STA to perform the switch from the reduced operating parameters to the enhanced operating parameters.
DPS Transition Delay: The time required by the STA at the end of a TXOP to perform the switch from the enhanced operating parameters to the reduced operating parameters.
Current DPS State: An indication of the current DPS state of the STA, indicating if the STA is currently operating in the low power state or high power state for succeeding threshold interval of time (e.g. till next beacon or next DTIM beacon).
An indication of the start time and periodicity of the periodic intervals where the DPS STA will operate with enhanced operating parameters by default. This indication can be carried, for example, by including the broadcast Target Wake Time (bTWT) IDs of bTWT elements that identify the periodic intervals. In this case the peer STA may directly communicate with the STA as per the enhanced operating parameters during these intervals.
An indication of the start time and periodicity of the periodic intervals where the DPS STA will operate with reduced operating parameters by default. This indication can be carried,

for example, by including the broadcast Target Wake Time (bTWT) IDs of bTWT elements that identify the periodic intervals. In this case the peer STA may communicate with the DPS STA as per the reduced operating parameters or send an initial control frame to request the DPS STA to transition to the enhanced operating parameters during these intervals.
An indication of the start time and periodicity of the periodic intervals where the DPS STA will operate with reduced operating parameters only. This indication can be carried, for example, by including the broadcast Target Wake Time (bTWT) IDs of bTWT elements that identify the periodic intervals. In this case the peer STA may communicate with the

DPS STA as per the reduced operating parameters during these intervals.
A Link ID field identifying the link, or a Link ID Bitmap identifying the link(s), for which the DPS parameters are applicable.
An indication of the traffic identifiers or access categories of the traffic that is transmitted in a TXOP for which a peer STA can request the DPS STA to switch to the enhanced capabilities.
An indication of the peer STAs that are allowed to request the DPS STA to switch to enhanced capabilities. This can be done by providing an Association ID list, or by a qualitative indication, e.g., only AP is allowed to be such a peer STA.
An indication of the time for which the DPS STA may operate with the enhanced operating parameters once an “enhanced-operation request” is received from a peer STA. This can be called, for example, Retention time or Hysteresis time or enhancedOpRequestedTimeout. The time can be, for example, in units of transmit units (TUs) or beacon intervals.
An indication of the time duration for which a DPS STA remains in the enhanced operating parameters mode after every beacon or every DTIM beacon. The time can be, for example, in units of TUs or beacon intervals and can be called enhancedOpPostBeaconTimeout.
An indication of the time duration for which a DPS STA remains in the enhanced operating parameters mode once it has indicated its DPS state as being enhanced state. The time can be, for example, in units of TUs or beacon intervals and can be called enhancedOpIndicatedTimeout.
An indication of the different DPS states that the DPS STA can operate in when in the DPS mode. This indication can be carried, for example, by using a bitmap, where a bit n is set to 1 to indicate that DPS State ID n is a candidate state for the DPS mode.
An indication of whether the DPS STA requires a DPS supporting peer STA to provide a frame with padding delay at the end of a TXOP to enable the switch of the DPS STA back

from enhanced operating parameters to reduced operating parameters. For example, if the DPS Transition Delay is smaller than a certain duration such as a DIFS duration, padding at end of the TXOP may not be needed.

Note that a different subset of these parameters may be applicable when the DPS STA is an AP or the DPS STA is a non-AP STA.

In some embodiments, when a DPS STA intends to update DPS operation it may signal one or more of the DPS parameters (described herein) along with an indication of the time when the update takes effect. In some embodiments, the update may include enabling/disabling DPS mode or changing one or more DPS parameters while the DPS mode is enabled, etc. This signaling can be included in either broadcast or unicast frames sent by the DPS STA. The indicated information may contain one or more of:
An indication of the presence of DPS information being signaled by the STA. This presence can, for example, be within the Beacon frames when the DPS STA is an AP.
A unique identifier to uniquely identify the specific DPS parameter update. This can, for example, be indicated in a Dialog Token field.
Currently operational DPS parameters, if applicable. This can include all or a subset of the parameters described in embodiment 0 above.
The updated values of DPS parameters to be used. This can include all or a subset of the parameters described in embodiment 0 above.
Indication of start time for the DPS operation/parameter update. This indication can be, for example, a counter indicating the expected start time in terms of target beacon transmit times.
Indication of the one or more links for which the update is applicable.

Note that the included parameters can be dependent on the type of update being performed. For example, when disabling DPS, the Updated parameters may only include the DPS mode field that indicates that the DPS mode is being disabled. When a few of the DPS updating parameters, only the subset of the parameters which are being updated may be included in the signaling. In another example, only the updated parameters can be included and currently operational DPS parameters may be skipped. In one embodiment, the indicated information may be dependent on whether the DPS STA is an AP or a non-AP STA.

In one variant, the indications can be carried in a new element/sub-element/frame, or in new fields of an existing element/sub-element/frame, or a new variant of an element/frame. In one embodiment the DPS STA may periodically transmit the indication of DPS parameter update while the update is pending. After the DPS parameter update is completed, i.e., the start time has elapsed the DPS STA may stop transmitting the indication.

In one embodiment, where the DPS STA is an AP, the aforementioned information can be included by the AP in one or more of Probe Response, Association Response and Beacon frames. In one variant, there can be a subfield to indicate the presence of the DPS Information element/sub-element within these frames. In another variant, the aforementioned information can be carried in a group-addressed frame transmitted by the DPS AP, and the presence of such a group addressed frame may be indicated within the Beacon, such as within the UHR Operation element or the TIM element. For example, the group addressed frame can be called UHR Auxiliary Information frame, which can have the DPS parameters as a subfield/sub-element, among others. In one example, the UHR Auxiliary Information frame can be a variant of an existing frame such as the Link Reconfiguration Request frame or Link Reconfiguration Response frame.

In one embodiment, when a DPS AP intends to update DPS operation it may signal one or more of the DPS parameters well in advance of the update, so that all associated STAs have sufficient time to have received the indication. For example, the AP may start announcing the update at least a Listen Interval before the Start time of the update. The upcoming change in DPS Operation Parameters (determined by inclusion of the DPS parameter update signaling) may be considered a critical update and may cause an increase in one or more of: the BSS Parameter Change Count field, setting of the Critical Update flag, the Check Beacon field etc.

In an embodiment where the DPS STA is a non-AP STA, the aforementioned information can be included by the non-AP STA in one or more of Probe Request and Association Request frames. In a variant, the indication can also be sent in a new Action frame or an existing Action frame transmitted by the non-AP STA. The new frame can be called, for example the DPS Notification frame or a UHR Operation Mode Notification frame, where there may be a field to indicate that the frame is for DPS parameter update notification. In one variant of this embodiment, a start time parameter may not be included and the new DPS parameters may come into effect either immediately or a fixed delay after the AP sends an appropriate response frame indicating either acknowledgement or acceptance of the parameters.

FIG. 5 illustrates an example of a DPS information element 500 according to embodiments of the present disclosure. The embodiment of the example of a DPS information element 500 shown in FIG. 5 is for illustration only. Other embodiments of the example of a DPS information element 500 could be used without departing from the scope of this disclosure.

In one example where the DPS STA is an AP, there can be a DPS specific new element/sub-element called DPS Information element. The format can be, for example, as shown in FIG. 5. This element/sub-element can be optionally included by the DPS STA in individually addressed and/or broadcast frames that it transmits, when there is an expected update to the DPS parameters. In one variant of this example, this element/sub-element can be included in all or a subset of the Beacon frames that the AP transmits. The element/sub-element may also be included in Probe Response and/or Association Response frames. In one variant of this example the element/sub-element may only be included in DTIM Beacons but not in other Beacon frames to reduce the beacon bloating issue.

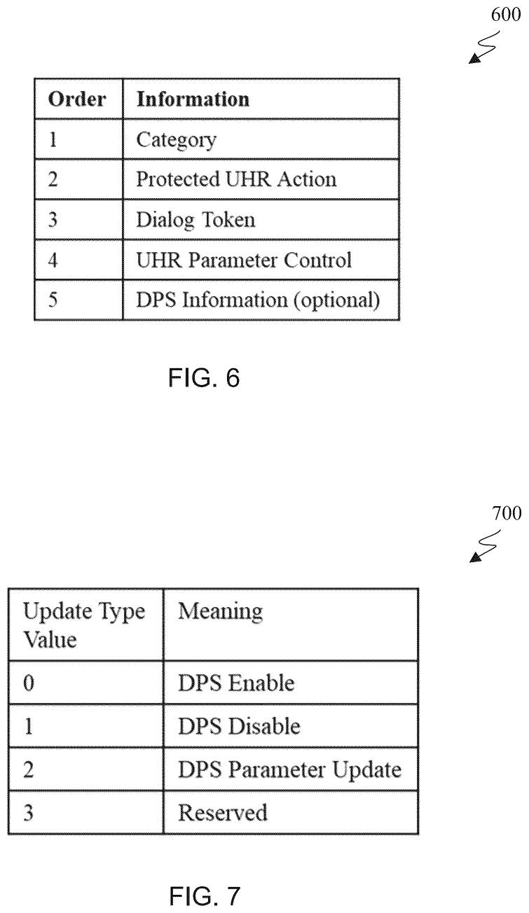

FIG. 6 illustrates an example of the UHR auxiliary parameters frame 600 according to embodiments of the present disclosure. The embodiment of the example of the UHR auxiliary parameters frame 600 shown in FIG. 6 is for illustration only. Other embodiments of the example of the UHR auxiliary parameters frame 600 could be used without departing from the scope of this disclosure.

As illustrated in FIG. 6, in another variant of this example, the element/sub-element may be included in a new group-addressed frame that is transmitted by the AP, called the UHR Auxiliary Parameters frame, as depicted in FIG. 6. The Auxiliary Parameters frame may have a UHR Parameter Control field to indicate that the frame is for update of DPS Parameters, and correspondingly the DPS Information may be optionally present in this frame. There can be a field in the Beacon frame transmitted by the AP to indicate the presence of a scheduled upcoming UHR Auxiliary Parameters frame to be transmitted by the AP. The transmission can be either only by the AP undergoing the change, or can be transmitted by any AP affiliated by the same AP MLD.

FIG. 7 illustrates an example of encoding of the update type subfield of the DPS information element/sub-element 700 according to embodiments of the present disclosure. The embodiment of the example of encoding of the update type subfield of the DPS information element/sub-element 700 shown in FIG. 7 is for illustration only. Other embodiments of the example of encoding of the update type subfield of the DPS information element/sub-element 700 could be used without departing from the scope of this disclosure.

The different fields of the DPS Information element/sub-element can be as described below:
The Update Type field can be of 2 bits with example encoding as shown in FIG 7.
The DPS Update Timer field indicates the time of the DPS update in units of Target Beacon Transmit Times (TBTTs).
The Link ID field identifies the link corresponding to the AP for which the DPS update is applicable. In a variant, instead of a link ID field, there can be a Link Bitmap field indicating all the links for which the DPS change is applicable.
The Unavailability TWT List indicates the periodic service periods where the AP is unavailable from DPS operation, i.e., communication can only happen in the Reduced Capability state of AP. This can be indicated by directly carrying TWT elements corresponding to the service periods, or by carrying TWT IDs corresponding to TWT elements that indicate the service periods. In the latter case the TWT elements may be separately indicated by the AP in the Beacons etc.
The Enhanced Parameter TWT List indicates the periodic service periods where the AP operates in the High Power state by default. This can be indicated by directly carrying TWT elements corresponding to the service periods, or by carrying TWT IDs corresponding to TWT elements that indicate the service periods. In the latter case the TWT elements may be separately indicated by the AP in the Beacons etc.

In a variant, all or some of the DPS Parameters described above are optionally present in the DPS Information element/sub-element. There may be a Presence Bitmap subfield in the DPS Information element/sub-element to indicate which of the different DPS Parameters are present.

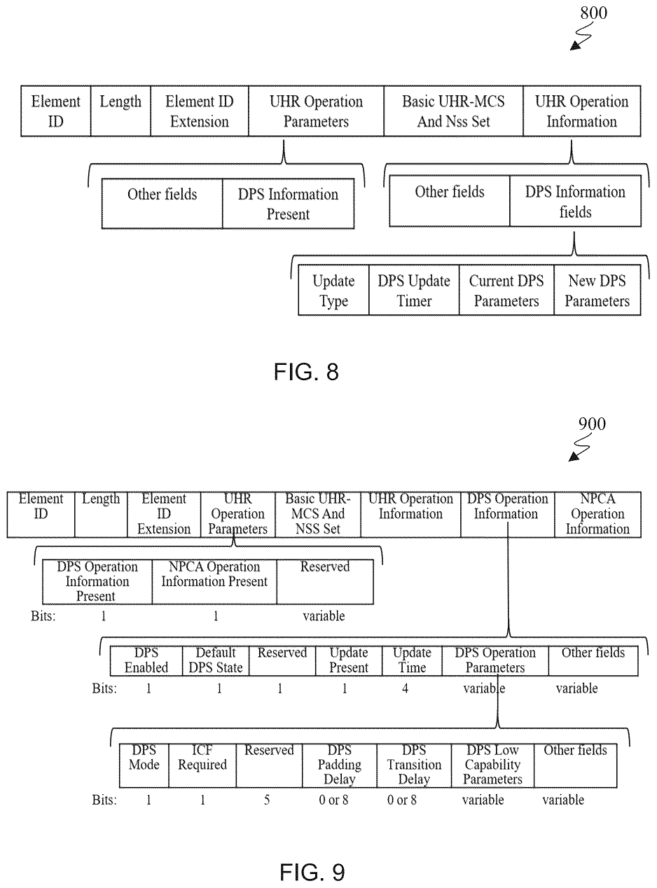

FIG. 8 illustrates an example of DPS information within a UHR operation element according to embodiments of the present disclosure. The embodiment of the example of DPS information within a UHR operation element 800 shown in FIG. 8 is for illustration only. Other embodiments of the example of DPS information within a UHR operation element 800 could be used without departing from the scope of this disclosure.

In one example where the DPS STA is an AP, there can be a DPS specific field called DPS Information field that is optionally present in the UHR Operation element. The format can be as depicted in FIG. 8. This field can be included in all or a subset of the UHR Operation elements transmitted by the AP in Beacon frames when there is an expected update to DPS parameters. For example, to reduce beacon bloating, the indication may only be carried in UHR Operation elements corresponding to DTIM beacons. The field may also be included in the UHR Operation elements transmitted by the AP in Probe response and/or Association response frames. The presence of the DPS Information field in the UHR Operation element may be indicated by a DPS Information Present subfield in the UHR Operation Parameters field of the UHR Operation element. The transmission can be either only by the AP undergoing the change, or can be transmitted by any AP affiliated by the same AP MLD. The different DPS Information fields may have similar definitions as described herein.

FIG. 9 illustrates another example of DPS information within a UHR operation element 900 according to embodiments of the present disclosure. The embodiment of the example of DPS information within a UHR operation element 900 shown in FIG. 9 is for illustration only. Other embodiments of the example of DPS information within a UHR operation element 900 could be used without departing from the scope of this disclosure.

In one example, where the DPS STA is an AP, the indications can be carried in the UHR Operation element, but the indication mechanism may be slightly different. In one variant of this example this indication mechanism may only be defined for certain types of APs, such as a mobile AP.

The UHR Operation element may have a DPS Operation Information Present field, which is set to 1 if the AP sending a frame containing the UHR Operation Parameters field has either enabled DPS operation at the AP or there is a scheduled update of DPS mode to be indicated. It is set to 0 otherwise. The UHR Operation element may also optionally include a DPS Operation Information field, which is present if the DPS Operation Information Present field is set to 1 and is not present otherwise. The format of the DPS Operation Information field can be as shown in FIG. 9. The encoding of the different fields of the DPS Operation Information field may be as follows:
The DPS Enabled field can be set to 1 by an AP to indicate that DPS mode is currently enabled at the AP. The field can be set to 0 to indicate that the DPS mode is currently disabled at the AP.
The Default DPS State field can be set to 1 by an AP to indicate that it may remain in the DPS high capability mode till the next target beacon transmit time (TBTT) on that link. The Default DPS State field can be set to 0 otherwise. The field can be reserved if DPS Enabled is set to 0.
The Update Present field can be set to 1 by an AP to indicate that updates to the DPS mode are scheduled at the AP. The field can be set to 0 if there are no upcoming changes to DPS mode scheduled at the AP.
The Update Time field can be reserved when Update Present field is set to 0. When Update Present field is set to 1, the Update Time field can indicate the TBTT at which the updates to DPS mode, indicated in the DPS Operation Parameters, take effect. The field can be set to a value of i if the DPS mode update is scheduled to occur at the TBTT of the i-th Beacon frame that follows the transmission of the DPS Operation Parameters field.
The DPS Operation Parameters field can be present when Update Present field is set to 1 and may not present otherwise. The DPS Operation Parameters field indicates the updated DPS mode parameters for the AP which will applicable at the indicated Update Time.

In a variant, the DPS Operation Information field may have a Link ID Bitmap field indicating the links for which the DPS update is applicable. In another variant, instead of a single DPS Operation Parameters field, there may be a DPS Operation Parameters List field in the DPS Operation Information field. The DPS Operation Parameters List field may containing n DPS Operation Parameters fields, if there are n bits set to 1 in the Link ID Bitmap field, and the i-th DPS Operation Parameters field may correspond to Link ID j, if bit j is the i-th bit set to 1 in the Link ID Bitmap field.

The encoding of the different fields of the DPS Operation Parameters field may be as follows:
The DPS Mode field can indicate if the DPS mode is being enabled/disabled and the type of DPS mode being enabled by the transmitting STA. The DPS Mode field can be set as follows:
   Set to 0 to indicate DPS mode is being disabled.
   Set to 1 to indicate DPS mode is being enabled, with the STA operating in default DPS mode.
   Set to 2 to indicate DPS mode is being enabled, with the STA operating in parameterized DPS mode.
   The value of 3 can be reserved.
The ICF Required field can indicate when the transmission to the STA should be initiated with a DPS ICF. The ICF Required field can be set to 0 by a STA to indicate that any frame exchange initiated with the STA that requires the STA to transition from a DPS low capability mode to a DPS high capability mode may be initiated with a DPS ICF. The ICF Required field can be set to 1 by the STA to indicate that any frame exchange initiated with the STA, while it is in DPS mode, may be initiated with a DPS ICF. The ICF Required field can be reserved when DPS Mode field is set to 0.
The DPS Padding Delay field can indicate the minimum MAC padding duration that is required by a DPS STA in an initial Control frame to cause the STA to transition from the lower capability mode to the higher capability mode.
The DPS Transition Delay field indicates the minimum amount of time required by a DPS STA to transition from the higher capability mode to the lower capability mode.
The DPS Low Capability Parameters field can indicate the capabilities (for e.g., supported channel widths, NSS, MCS indices, and PPDU formats) of the transmitting STA when operating in the low capability mode of parameterized DPS mode. The field may not be present if DPS Mode field is not set to the value of 2.

An illustration of these fields is shown in FIG. 9. In a variant of this example, the above encoding of the DPS Operation Parameters field may also be valid for a non-AP STA. In other words, when a non-AP STA performs an update of its DPS operation, it may include the DPS Operation Parameters field defined herein for indicating the changes.

To enable DPS mode with specific parameters, or disable DPS mode, an AP can:
set the DPS Operation Information Present field of the UHR Operation Parameters field of the UHR Operation element it transmits to 1,
set the Update Present field of the DPS Operation Information Present field to 1,
set the Update Time field of the DPS Operation Information Present field to the TBTT at which DPS mode or parameters will be updated,
indicate the DPS parameters applicable at the update time in the DPS Operation Parameters field of the DPS Operation Information field.

The AP may carry the indication of the mode update in the UHR Operation element, for a period of time before the update is applicable, to allow associated STAs in PS mode to receive the notification. Note that changing DPS parameters while keeping DPS mode enabled may also follow this procedure.

In this example, the AP may operate in two types of DPS modes: (i) a Default DPS mode or (ii) a Parameterized DPS mode.
To enable default DPS mode, the AP can set the DPS Mode field of the DPS Operation Parameters field of the DPS Operation Information field to a value of 1. When operating in default DPS mode, the AP in its low capability state may be capable of receiving PPDUs in non-HT or non-HT duplicate format using a rate of 6 Mb/s, 12 Mb/s, or 24 Mb/s.
To enable parameterized DPS mode, the AP can set the DPS Mode field of the DPS Operation Parameters field of the DPS Operation Information field to a value of 2. When operating in parameterized DPS mode, the capabilities (e.g., PPDU formats, channel widths, MCS indices and NSS) supported by the AP in the Low Capability state can be indicated in the DPS Low Capability Parameters field of the DPS Operation Parameters field of the DPS Operation Information field.

To disable DPS mode, the AP can set the DPS Mode field of the DPS Operation Parameters field of the DPS Operation Information field to a value of 0.

A DPS AP can set the DPS Operation Information Present field and the DPS Enabled field of the DPS Operation Information field of the UHR Operation element it transmits to 1, to indicate that DPS is enabled at the AP.

A DPS AP may set the Default DPS State field of the DPS Operation Information field of the UHR Operation element it transmits in a Beacon frame to 1 to indicate that it may remain in the DPS high capability mode till the TBTT corresponding to the next Beacon frame on that link.

A DPS assisting non-AP STA that receives a UHR Operation element from a DPS AP with the Default DPS State field of the DPS Operation Information field set to 1, may initiate a transmission to the AP as per the AP's High Capability state capabilities without transmitting an DPS ICF, till the next TBTT on that link.

A DPS non-AP STA that initiates a frame exchange with a DPS AP and that expects the AP to transition from High Capability state to Low Capability state at the end of the frame exchange can terminate the frame exchange such that there is sufficient time for the AP to send any applicable response frame and complete the mode transition before the NAV end time of the TXOP.

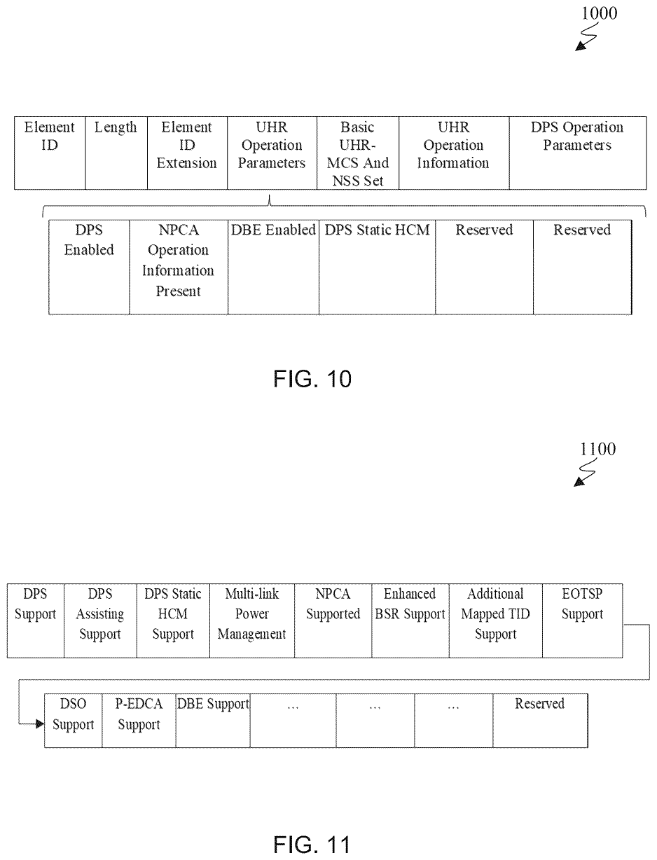

FIG. 10 illustrates an example of a DPS static HCM field in the UHR operation parameters field of the UHR operation element 1000 according to embodiments of the present disclosure. The embodiment of the example of a DPS static HCM field in the UHR operation parameters field of the UHR operation element 1000 shown in FIG. 10 is for illustration only. Other embodiments of the example of a DPS static HCM field in the UHR operation parameters field of the UHR operation element 1000 could be used without departing from the scope of this disclosure.

As illustrated in FIG. 10, in a variant of examples or embodiments described herein, the Default DPS State field may be called by other names, such as, the DPS Extended High Capability Mode (HCM) field or the DPS Sustained HCM field, DPS Prolonged HCM field, DPS Static HCM field etc., and it may be carried in the UHR Operations Parameter field of the UHR Operations element, as depicted in FIG. 10. The DPS Static HCM field can be set to 1 by an AP operating in DPS mode to indicate that it will remain in the DPS high capability mode till the next TBTT on that link, and can be set to 0 otherwise. The field may be reserved if the DPS Enabled field is set to 0.

FIG. 11 illustrates an example of a DPS static HCM support field in the UHR MAC capabilities information field 1100 according to embodiments of the present disclosure. The embodiment of the example of a DPS static HCM support field in the UHR MAC capabilities information field 1100 shown in FIG. 11 is for illustration only. Other embodiments of the example of a DPS static HCM support field in the UHR MAC capabilities information field 1100 could be used without departing from the scope of this disclosure.

As shown in FIG. 11, in a variant, not all APs that enable DPS operation may support operating in the high capability state for a sustained duration till the next Beacon interval. Correspondingly, there may be a capability bit in the UHR MAC Capabilities Information field of the UHR Capabilities element to indicate whether a transmitting AP can maintain the DPS HCM from one Beacon frame till the next TBTT. This field can be called, for example, DPS Static HCM Support field, as shown in FIG. 11, and its encoding can be as follows:
For an AP MLD, it is set to 1 if the AP, while operating in DPS mode, is capable of operating in DPS HCM from one Beacon frame till the next TBTT. It is set to 0 otherwise.
The field may be reserved for a non-AP STA.

There may also be a MIB variable dot11UHRDPSStaticHCMImplemented defined to indicate if an AP supports being the HCM for an extended duration till the next target beacon transmit time. For example, the MIB variable definition can be as follows:
dot11UHRDPSStaticHCMImplemented OBJECT-TYPE
   SYNTAX TruthValue
   MAX-ACCESS read-only
   STATUS current
   DESCRIPTION
      “This is a capability variable.
      Its value is determined by device capabilities.
      This attribute, when true, indicates that the STA implementation is capable of remaining the HCM till the next TBTT.”
   ::={Dot11UHRStationConfigEntry7 }

Note that the value 7 in the above ConfigEntry variable is just a placeholder and another value may also be chosen in the standard document.

A UHR AP that has dot11UHRDPSStaticHCMImplemented equal to 1 can set the DPS Static HCM Support field to 1 in the UHR Capabilities element in Management frames that it transmits. Otherwise the UHR AP can set the DPS Static HCM Support field to 0.

A DPS AP with dot11UHRDPSStaticHCMImplemented equal to 1 may set the Mobile AP DPS Static HCM field of the UHR Operation Parameters field of the UHR Operation element in a Beacon frame it transmits to 1, to indicate that it will remains in the DPS HCM till the TBTT corresponding to the next Beacon frame. The AP may set the field to 0 otherwise. The DPS Static HCM field of the UHR Operation Parameters field of the UHR Operation element may be reserved or not present when transmitted by a UHR AP that has dot11UHRDPSStaticHCMImplemented equal to 0.

In a variant the aforementioned features may only be applicable for a mobile AP and not all APs.

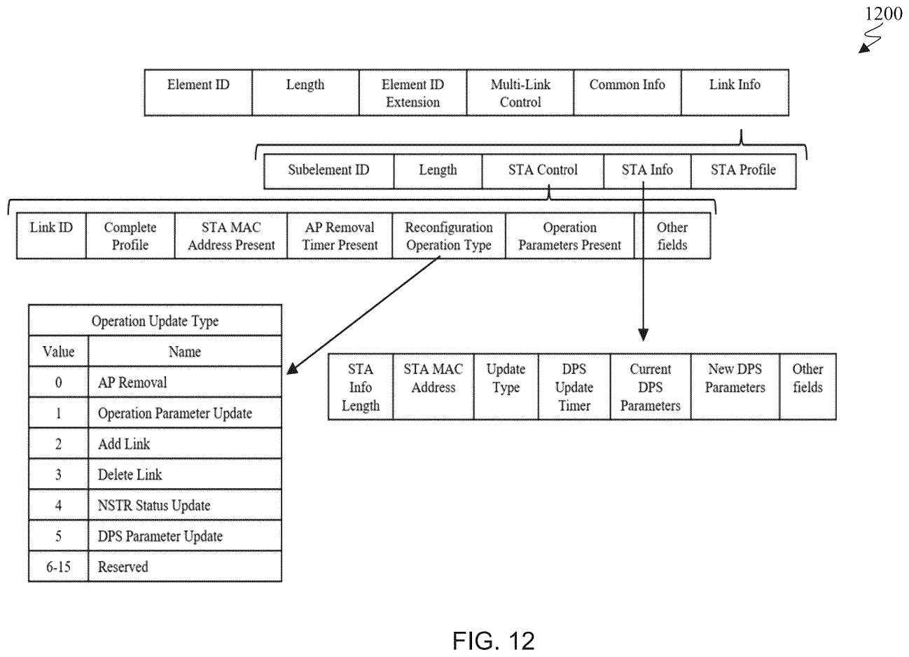

FIG. 12 illustrates an example of DPS information in the reconfiguration multi-link element 1200 according to embodiments of the present disclosure. The embodiment of the example of DPS information in the reconfiguration multi-link element 1200 shown in FIG. 12 is for illustration only. Other embodiments of the example of DPS information in the reconfiguration multi-link element 1200 could be used without departing from the scope of this disclosure.

As shown in FIG. 12, in one example where the DPS STA is an AP, there can be a new sub-type of an existing element to indicate the updated DPS parameters, such as the Reconfiguration Multi-Link element or a new variant of a multi-link element. The indication can be carried in the Per-STA Profile sub-element corresponding to that AP, as depicted in FIG. 12. This Reconfiguration Multi-Link element or new variant of multi-link element can be included in all or a subset of the Beacon frames transmitted when there is an expected update to DPS parameters. For example, to reduce beacon bloating, the indication may only be carried in DTIM beacons. The transmission of the Reconfiguration Multi-link element or new variant of multi-link element can be either only by the AP undergoing the change, or can be transmitted by any AP affiliated by the same AP MLD. The Reconfiguration Multi-Link element or new variant of multi-link element may also be included in the Probe Response and/or Association Response frames and/or Reduced Neighbor Reports transmitted by the AP. A special value (for example value 5) of the Reconfiguration Operation Type field of the STA Control field of the element may indicate that the element carries an indication of update to DPS parameters. When the Reconfiguration Operation Type subfield is set to this value, the Reconfiguration Multi-link element may further have the following features:
The AP Removal Timer field of the STA Info field may be redefined to indicate the start time of the DPS parameter update. In this case, a separate DPS Update Timer field may not be required in the STA Info field.
The different DPS parameters may be carried in a DPS Operation Parameters field of the STA Info field.

Most fields in FIG. 12 here may have similar definitions as in one or more examples described above.

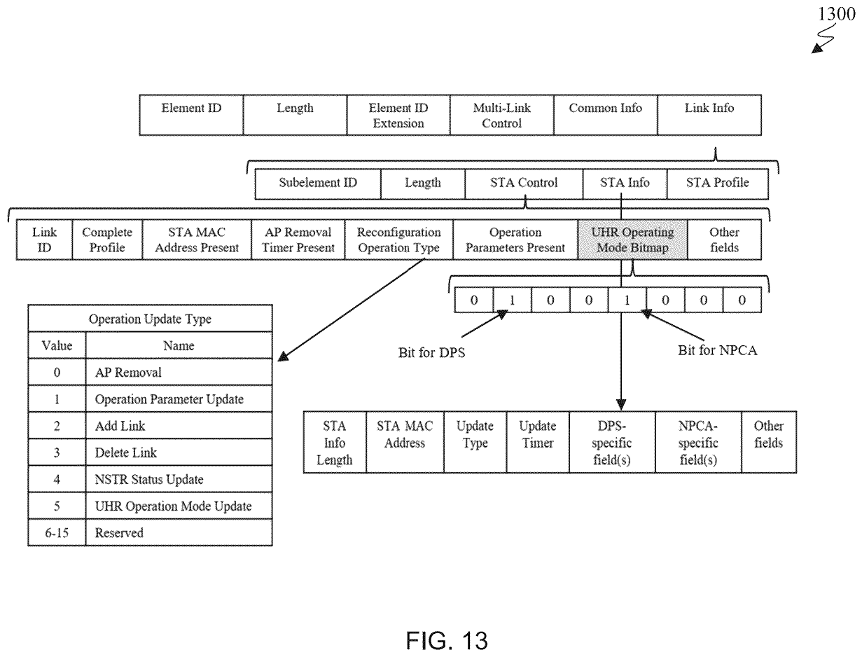

FIG. 13 illustrates an example of indicating updates to multiple UHR operation modes in the reconfiguration multi-link element 1300 according to embodiments of the present disclosure. The embodiment of the example of indicating updates to multiple UHR operation modes in the reconfiguration multi-link element 1300 shown in FIG. 13 is for illustration only. Other embodiments of the example of indicating updates to multiple UHR operation modes in the reconfiguration multi-link element 1300 could be used without departing from the scope of this disclosure.

As shown in FIG. 13, in one example, the special value of Reconfiguration Operation Type can be common for a set of AP UHR features, such as DPS, NPCA, DSO, DBE, Co-existence etc. This operation update type can be called, for example, UHR Operation Mode Update. Correspondingly, when this special value of Reconfiguration Operation Type is used in the STA Control field, there may be a UHR Operating Mode Bitmap field with each bit representing one of these set of AP UHR features. This UHR Operating Mode Bitmap field can be, for example, in either the STA Control or the STA Info field. When a bit corresponding to a feature in this UHR Operating Mode Bitmap is set to 1, then the parameters corresponding to that feature may be included in the STA Info field, for e.g., in a feature-specific field for that feature. In one variant, only one bit of this UHR Operating Mode Bitmap may be set to 1 at a time. In another variant, multiple bits of this UHR Operating Mode Bitmap can be set to 1 to indicate that updates to multiple features is taking place at the same time. In this case, the order of the feature-specific parameters in the STA Info field may follow the same order as the bits set to 1 in the Bitmap. This is exemplified pictorially in FIG. 13. The time of the parameter update may be indicated in a Start Time field that reuses the same field as the AP Removal Time field of the STA Info field. In a variant, instead of having a UHR Operating Mode Bitmap, each feature may have a unique element/sub-element identified by an element ID or sub-element ID. Updates to that feature can be indicated simply by including that element in the STA Info field or in a field carried in the same frame as the Reconfiguration multi-link element.

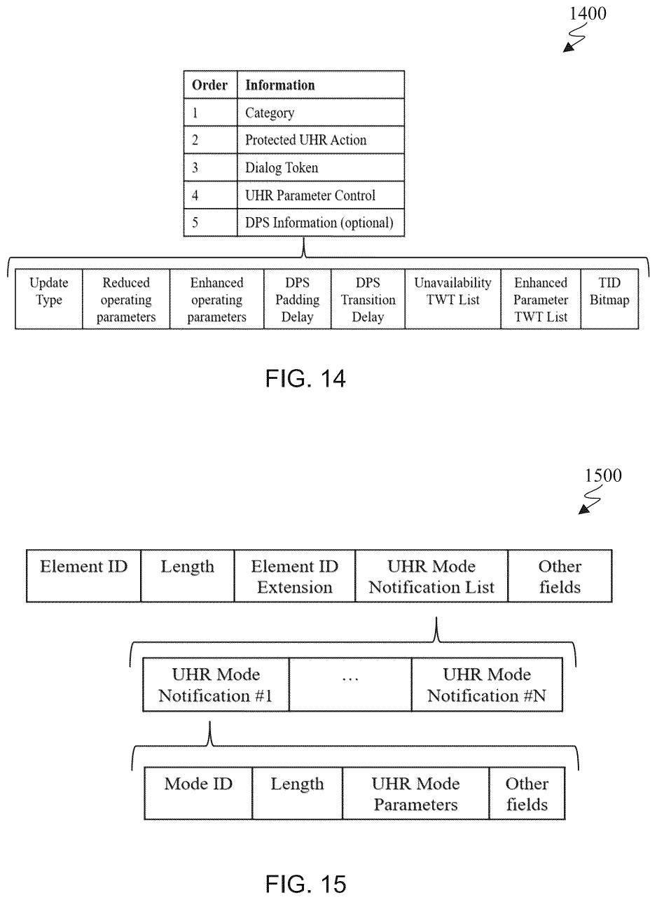

FIG. 14 illustrates an example of the DPS parameter indication in a UHR Operation Mode Notification frame sent by a non-AP DPS STA 1400 according to embodiments of the present disclosure. The embodiment of the example of the DPS parameter indication in a UHR Operation Mode Notification frame sent by a non-AP DPS STA 1400 shown in FIG. 14 is for illustration only. Other embodiments of the example of the DPS parameter indication in a UHR Operation Mode Notification frame sent by a non-AP DPS STA 1400 could be used without departing from the scope of this disclosure.

As shown in FIG. 14, in one example, where the DPS STA is a non-AP STA, the indications can be carried in a new action frame called DPS Notification frame. In a variant, the frame can be common to multiple UHR features, called UHR Operating Mode Notification frame, as depicted in FIG. 14. Within the UHR Operating Mode Notification frame, there can be a Parameter Control field indicating the purpose of the notification. Correspondingly within this Parameter Control field there may be an indication that the notification is for DPS parameter update. The frame may also include a Dialog Token field to uniquely identify the DPS Parameter Update when the AP sends a response. The frame transmission can be either only by the STA undergoing the change, or can be transmitted by any STA affiliated by the same non-AP MLD. The fields of the DPS Information may have similar definition as in one or more examples described above.

In another variant of this example, the DPS Information field may have a format similar to the DPS Operation Parameters field described herein and may have a similar encoding for one or more of the fields.

FIG. 15 illustrates an example of the format of the UHR mode change element 1500 according to embodiments of the present disclosure. The embodiment of the example of the format of the UHR mode change element 1500 shown in FIG. 15 is for illustration only. Other embodiments of the example of the format of the UHR mode change element 1500 could be used without departing from the scope of this disclosure.

In one example, a new element may be defined for indicating changes to one or more UHR modes, including one or more of DPS, NPCA, DBE, P-EDCA, Co-BF, Co-SR, LLI, DUO, AOM etc. The format of this new element may be as shown in FIG. 15. Here the UHR Mode Notification List contains one or more UHR Mode Notification fields. The format of the UHR Mode Notification field can be as shown in FIG. 15. The Mode ID field may indicate the UHR mode of operation that is requested to be enabled, disabled, or updated using this field. For example, the Mode ID field value of 0 may correspond to changes in DPS mode or in DPS parameters. The UHR Mode Parameters field may carry the updated parameters corresponding to the mode indicated in the Mode ID field.

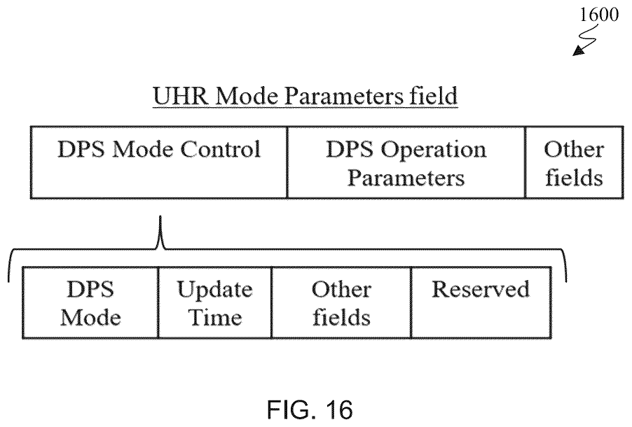

FIG. 16 illustrates an example of the DPS-variant UHR mode parameters field when the mode ID indicates DPS mode 1600 according to embodiments of the present disclosure. The embodiment of the example of the DPS-variant UHR mode parameters field when the mode ID indicates DPS mode 1600 shown in FIG. 16 is for illustration only. Other embodiments of the example of the DPS-variant UHR mode parameters field when the mode ID indicates DPS mode 1600 could be used without departing from the scope of this disclosure.

When the Mode ID field indicates DPS, e.g., with a value of 0, the format of the UHR Mode Parameters field can be as shown in FIG. 16, which has a DPS Mode Control field and optionally has a DPS Operation Parameters field. It may also have some other fields. The DPS Mode field may further have subfields as shown in FIG. 16. The DPS Mode field may be of 2 bits and may indicate if the DPS mode is being enabled/disabled and the type of DPS mode being enabled by the transmitting STA. The DPS Mode field can be set as follows:
Set to 0 to indicate DPS mode is being disabled.
Set to 1 to indicate DPS mode is being enabled, with the STA operating in default DPS mode.
Set to 2 to indicate DPS mode is being enabled, with the STA operating in parameterized DPS mode.
The value of 3 may be reserved.

The Update Time field, when transmitted by an AP, may indicate the TBTT at which the updates to DPS mode, indicated in the DPS Operation Parameters, take effect. The field can be set to a value of i if the DPS mode update is scheduled to occur at the TBTT of the i-th Beacon frame that follows the transmission of the DPS Operation Parameters field. The Update Time field can be set to 0 when carried in a DPS Mode Control field that is transmitted after the scheduled start time of the indicated DPS update. The Update Time field can be reserved when the DPS Mode Control field is transmitted by a non-AP STA.

The DPS Operation Parameters field can be present when the DPS Mode field is set to 1 or 2; otherwise, the DPS Operation Parameters field may not be present. When present, then the DPS Operation Parameters field can indicate the updated DPS mode parameters including one or more of: DPS Padding Delay, DPS Transition Delay, and the capabilities in the low power state including maximum supported bandwidth, maximum supported number of spatial streams, maximum supported PHY version of PPDUs etc.

A UHR non-AP STA may enable the DPS mode if its associated AP is a DPS Assisting AP. To enable DPS mode, update DPS parameters, or disable DPS mode at a first non-AP STA, any non-AP STA affiliated with the same MLD may transmit a Link Reconfiguration Notify frame and include, in the Per-STA Profile sub-element of the Reconfiguration Multi-link element corresponding to the first STA, a UHR Mode Change element containing a UHR Mode Notification field with the Mode ID field set to 0. The UHR Mode Notification field may include the DPS-variant UHR Mode Parameters field with the Update Time field set to 0 and the DPS Mode field set as follows:
The DPS Mode Field Can Be Set to 0 to Disable DPS Mode.
The DPS Mode field can be set to 1 to enable Basic DPS mode. The same encoding, in a variant, may also be used to update the DPS parameters while operating in the Basic DPS mode.
The DPS Mode field can be set to 2 to enable Parameterized DPS mode. The same encoding, in a variant, may also be used to update the DPS parameters while operating in the parameterized DPS mode.

When the DPS Mode field is set to either 1 or 2, the DPS Operation Parameters field may indicate the new requested parameters of the DPS mode. The DPS Operation Parameters field may not be present when the DPS Mode field is set to 0. Upon receiving the Link Reconfiguration Notify frame from an associated non-AP STA to enable DPS mode, the AP may respond with a Link Reconfiguration Response frame to the non-AP STA, after the AP is ready to serve the non-AP STA in the updated mode. In a variant the indication can be in some other element apart from the Reconfiguration Multi-link element.

To enable DPS mode, update DPS parameters, or disable DPS mode, at an AP of an AP MLD, each AP of the AP MLD may perform all of the following:
Include a Reconfiguration Multi-link element in the Beacon, Probe Response and Association Response frames it transmits.
Include in the Reconfiguration Multi-link element a UHR Mode Change element containing a UHR Mode Notification field with the Mode ID field set to 0 in the Per STA Profile sub-element of the corresponding to the AP for which the DPS mode change is applicable.
Set the DPS Mode field of the DPS Mode Notification field to indicate the DPS mode change.
Set the Update Time field of the DPS Mode Notification field to indicate the number of remaining TBTTs after which DPS mode or parameters will be updated.
Indicate the DPS parameters applicable at the update time in the DPS Operation Parameters field of the DPS Mode Notification field.

In a variant the indication can be in some other element apart from the Reconfiguration Multi-link element.

Each AP of the AP MLD may carry the indication of the mode update in the Reconfiguration Multi-link element of Beacon, Probe Response and Association Response frames for a fixed period of time before the update is applicable, to allow associated STAs in PS mode to receive the notification. This fixed period of time may be defined by the standard or may be up to implementation.

In the case where the changes correspond to a non-transmitted BSSID profile, the updaters may be carried in the Beacon corresponding to the transmitted BSSID that is part of the same multiple BSSID set as the non-transmitted BSSID profile.

While DPS mode is enabled at an AP of an AP MLD, each AP of the AP MLD may:
Include a Reconfiguration Multi-link element in Probe Response and Association Response frames it transmits.
Include in the Reconfiguration Multi-link element a UHR Mode Change element containing a UHR Mode Notification field with the Mode ID field set to 0 in the Per STA Profile sub-element of the corresponding to the AP for which the DPS mode is enabled.
Set the DPS Mode field of the DPS Mode Notification field to indicate the type of DPS mode enabled.
Set the Update Time field of the DPS Mode Notification field to 0.
Indicate the applicable DPS parameters in the DPS Operation Parameters field of the DPS Mode Notification field.
Set the DPS Enabled field of the UHR Operation element it transits to 1, if the DPS mode is enabled at the transmitting AP. Otherwise the AP may set the DPS Enabled field to 0.

In a variant the indication can be in some other element apart from the Reconfiguration Multi-link element.

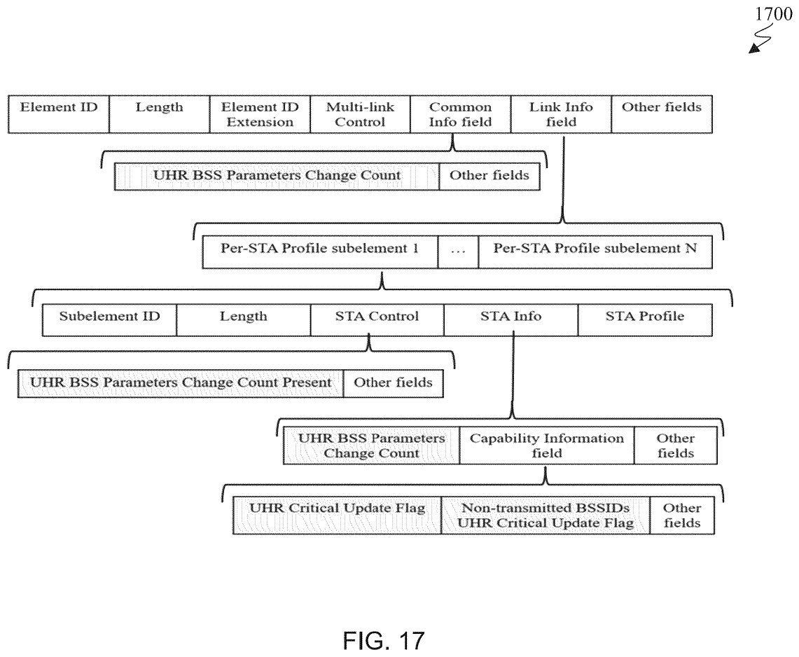

FIG. 17 illustrates an example of the UHR BSS Parameter Change Count field and UHR Critical Update Flag indication in a Basic Multi-link element 1700 according to embodiments of the present disclosure. The embodiment of the example of the UHR BSS Parameter Change Count field and UHR Critical Update Flag indication in a Basic Multi-link element 1700 shown in FIG. 17 is for illustration only. Other embodiments of the example of the UHR BSS Parameter Change Count field and UHR Critical Update Flag indication in a Basic Multi-link element 1700 could be used without departing from the scope of this disclosure.

As stated above, in one embodiment where the DPS STA is an AP, the upcoming change in DPS Operation Parameters (determined by inclusion of the DPS parameter update signaling) may be considered a critical update and may cause an increase in one or more of: the BSS Parameters Change Count field, setting of the Critical Update flag, the Check Beacon field etc. In another embodiment where the DPS STA is an AP, to ensure that other STAs, such as STAs belonging to an older Wi-Fi generation, are not unnecessarily indicated about the updates, which may cause them to transmit Probe Request frames, a new type of UHR Critical Update flag and/or UHR BSS Parameters Change Count indication may be defined. In one example, these indications may have a similar format as the Critical Update flag and the BSS Parameters Change Count field, but they may be updated only for changes to UHR-specific features that do not impact other STAs (such as STAs belonging to Wi-Fi generations EHT and before). These indications can be carried, for example, in UHR-specific fields or elements, such has the UHR Operation element or the UHR Capabilities element or a UHR-specific field of the Basic Multi-link element. An AP parameter change that impacts only UHR or beyond STAs and can be ignored by other STAs (such as STAs belonging to an older Wi-Fi generation) may be called, for example, a UHR critical update. In a variant of this embodiment, the upcoming changes to DPS Operation Parameters may be considered a UHR critical update and may cause an update to the UHR Critical Update flag and/or UHR BSS Parameters Change Count field but not to the Critical Update flag and BSS Parameters Change Count field.

The UHR BSS Parameters Change Count value may be separate for each AP of an AP MLD. The UHR BSS Parameters Change Count field can be an unsigned integer, which is initialized to 0. It may count up in value by 1 whenever there is a UHR Critical update for the AP transmitting the field or another AP that corresponds to a non-transmitted BSSID that is a member of the same multiple BSSID set as the transmitting AP. UHR BSS Parameters Change Count may have a length of 8 bits. Correspondingly, the field may increment to a maximum value, such as 255, and then wrap around.

A UHR AP may indicate the UHR BSS Parameters Change Count fields for all or some of its affiliated STAs in the Beacon, Probe Response and Association Response frames it transmits. These fields may be carried in, for example:
The Reduced Neighbor Report element
The Common Info field of the Basic Multi-link element
The Per-STA Profile sub-element of the Basic Multi-link element, etc.
A new UHR-specific element.

In a variant the AP may also indicate UHR BSS Parameters Change Count fields for STAs of other AP MLDs that are part of the same multiple BSSID set as the AP. The indication mechanism may be different depending on whether the UHR BSS Parameters Change Count field corresponds to the AP transmitting the link, or belongs to another AP of the same AP MLD, or another AP of the same BSSID set as the transmitting AP. An illustration of the field indication in different locations of the Basic Multi-link element is depicted in FIG. 17.

In one example, some of these UHR BSS Parameters Change Count fields may be present in the Common Info field of the Basic Multi-link element. In one embodiment, the UHR BSS Parameters Change Count may always be present in the Basic Multi-link element transmitted by a UHR AP. In another embodiment, it may be optionally present when transmitted by a UHR AP. For example, it may not be present when the element is included in an Authentication frame or an FT action frame. Correspondingly, there may be a UHR BSS Parameters Change Count Present field in the Multi-link Control field of the Basic Multi-link element to indicate whether the UHR BSS Parameters Change Count is present in the element. The UHR BSS Parameters Change Count Present subfield can be set to 1 if the UHR BSS Parameters Change Count field is present in the Common Info field. Otherwise, the UHR BSS Parameters Change Count Present subfield can be set to 0. In a variant, this presence field may reuse the same field as the existing BSS Parameters Change Count Present field. In one variant, the UHR BSS Parameters Change Count field may not be present in the Basic Multi-Link element transmitted by a non-AP STA.

In one embodiment, some of these UHR BSS Parameters Change Count fields may be present in the STA Info field of the Per-STA Profile sub-element of the Basic Multi-link element. There may be a UHR BSS Parameters Change Count Present field in the STA Control field to indicate the presence of this field in the Per-STA Profile sub-element. It can be set to 1 if the UHR BSS Parameters Change Count subfield is present in the STA Info field. Otherwise, it can be set to 0. A non-AP STA may set this subfield to 0 in the Basic Multi-Link element that it transmits. An AP may set this subfield to 1 in the Basic Multi-Link element carried in a (Re)Association Response frame and may set it to 0 in other frames.

In one embodiment, some of these UHR BSS Parameters Change Count fields may be present in the Reduced Neighbor Report element. In one embodiment, there may be an All UHR Updates Included field along with the UHR BSS Parameters Change Count in the Reduced Neighbor Report element to indicate if the updated elements that correspond to the latest UHR critical update that generated a change to the value carried in the UHR BSS Parameters Change Count field for the reported AP are included in the frame carrying the Reduced Neighbor Report element. The All UHR Updates Included field can be set to 1 if all the updated elements are included and can be set to 0 otherwise.

The UHR BSS Parameters Change Count subfield for the AP operating on the non-primary link of an NSTR mobile AP MLD may only be advertised on the primary link in the MLD Parameters subfield in the TBTT Information field of the Reduced Neighbor Report element corresponding to that AP.

A UHR non-AP MLD may maintain a record of the most recently received UHR BSS Parameters Change Count field value for each associated AP affiliated with the AP MLD. When a non-AP STA affiliated with a non-AP MLD receives a UHR BSS Parameters Change Count field for a certain AP that is affiliated with an AP MLD with which the non-AP MLD has performed an ML setup and that operates on the link that is part of the ML setup, and the value of the UHR BSS Parameters Change Count subfield for the AP is different from the previously received value, then the non-AP MLD may either attempt to receive a Beacon frame or Probe Response frame from the AP or it may attempt to send a Probe Request frame to its associated AP to get the updated information. The non-AP STA may not follow this procedure if the value in the UHR BSS Parameters Change Count subfield is equal to the most recently received value recorded by the non-AP MLD for that AP plus 1 and if the All Updates Included subfield and/or All UHR Updates Included subfield in the MLD Parameters subfield in the TBTT Information field of the Reduced Neighbor Report element corresponding to the AP is set to 1.

The UHR Critical Update Flag may be separate for each AP of an AP MLD. The UHR Critical Update Flag corresponding to any AP may be of length 1 bit and it may be set to 1 when there is a UHR critical update for the AP. When the UHR Critical Update flag for one AP is transmitted by another AP, the value of 1 may be retrained by further transmissions of this flag by the second AP until the next DTIM Beacon (including the Beacon) of the second AP.

The UHR Critical Update flag may be carried in the Capability Information field of the Per-STA Profile sub-element of the Basic Multi-link element transmitted by an AP in Beacon and Probe Response frames. The field may be reserved when transmitted by a UHR non-AP STA and by pre-UHR STAs. In a variant, there may also be a Non-transmitted BSSIDs UHR Critical Update Flag, which indicates if there is a UHR Critical update for any AP corresponding to the other APs in the multiple BSSID set as the transmitting AP.

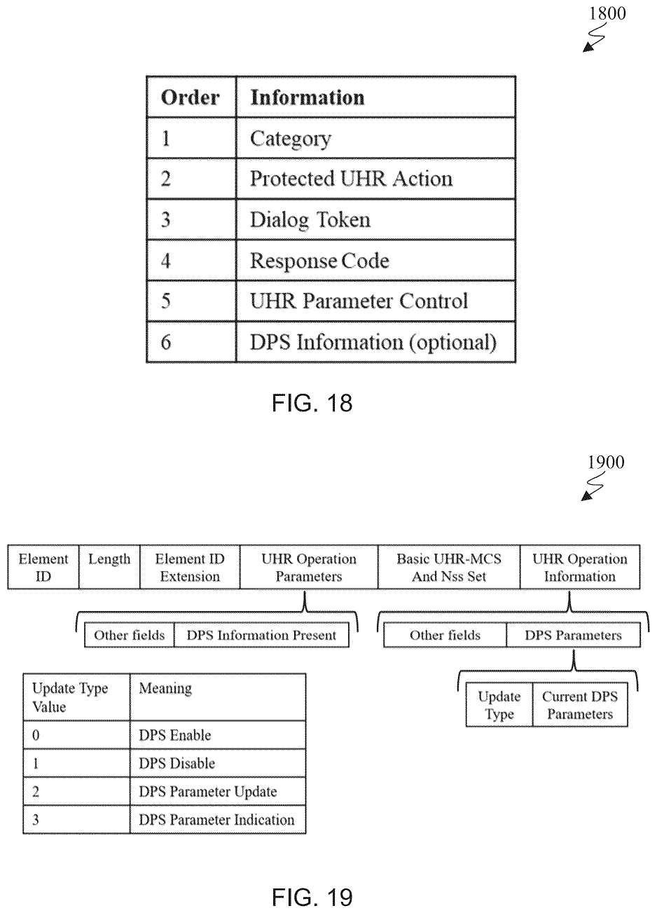

FIG. 18 illustrates an example of the UHR Operation Mode Notification frame sent by an AP in response to the DPS parameter update notification received from a DPS non-AP STA 1800 according to embodiments of the present disclosure. The embodiment of the example of the UHR Operation Mode Notification frame sent by an AP in response to the DPS parameter update notification received from a DPS non-AP STA 1800 shown in FIG. 18 is for illustration only. Other embodiments of the example of the UHR Operation Mode Notification frame sent by an AP in response to the DPS parameter update notification received from a DPS non-AP STA 1800 could be used without departing from the scope of this disclosure.

In one embodiment where the DPS STA is an AP, a non-AP STA upon receiving an indication of the critical update (or UHR critical update in some embodiments) may acquire the updated parameters either by:
Transmitting a Probe Request or Multi-link Probe Request frame to the AP.
Receiving a subsequent Beacon or group-addressed frame, at the anticipated transmission time of the frame.
Receiving a Probe Response frame sent by the AP.

A non-AP STA that received an indication in a Beacon about presence of a group-addressed frame containing updated DPS parameters may be ready to receive the group addressed frame at the anticipated transmission time of the frame.

In one embodiment where the DPS STA is a non-AP STA, the AP upon receiving an indication of update of DPS parameters may send a response frame to confirm the change of the DPS parameters. The response frame can be, for example, similar in format to the notification frame sent by the non-AP STA to indicate the update of DPS parameters. The response frame may include one or more of:
An identifier of the request frame to which the response corresponds to.
An indication of whether the AP accepts/rejects or suggests modifications to the DPS parameters indicated by the DPS non-AP STA.
A replication of one or more of the DPS parameters indicated by the non-AP STA in the notification frame.

One or more of additional rules or features may apply for the response sent by the AP, such as:
The response may need to be sent by the AP within a fixed interval of time from receiving the indication of update from the non-AP STA. If the response is not sent within this time, which the DPS parameters may be directly applied by the non-AP STA without receiving the response.
It may be optional for the AP to accept some types of update of DPS parameters indicated by the non-AP STA. In this case, if the AP rejects the response, it may send a suggested set of alternate DPS parameters to be used by the non-AP STA in future requests for DPS parameter update it sends.

An example of the response UHR Operating Mode Notification frame sent by the AP is depicted in FIG. 18. Here the Dialog Token may help identify the request frame in whose response the response frame is being transmitted by the AP. The Response Code field may indicate whether the response frame is accepting or rejecting the request, and if it is suggesting an alternate set of DPS parameters to be used. In the latter case, the suggested DPS parameters may be carried in the optional DPS Information field.

FIG. 19 illustrates an example of the DPS AP indicating the DPS operation parameters within the UHR Operation element 1900 according to embodiments of the present disclosure. The embodiment of the example of the DPS AP indicating the DPS operation parameters within the UHR Operation element 1900 shown in FIG. 19 is for illustration only. Other embodiments of the example of the DPS AP indicating the DPS operation parameters within the UHR Operation element 1900 could be used without departing from the scope of this disclosure.

In one embodiment where the DPS STA is an AP, some DPS parameters may be periodically indicated by an AP for its BSS while the DPS mode is enabled. In a variant, this indication may be present when there are no impending DPS parameter updates. The indication can be, for example in a new DPS-specific element/frame or can be in the fields of an existing element/frame, a new variant of an existing element/frame. In one example, the indication can be in a DPS Information element. In another example, the parameters can be carried in the UHR Operation element as depicted in FIG. 19. In this case, the presence of the DPS Parameters in the UHR Operation Information is indicated in the DPS Information Present field of the UHR Operation Parameters field of the UHR Operation element. In this case, the Update Type subfield of the DPS Parameters field can be set to 3 to indicate that current DPS Parameters are being indicated (without any pending update). In this case the Start Timer and Updated DPS Parameter fields may not be present. Similar examples can also be present for when the indication is carried in a new DPS-specific element etc.

In one variant, the indication may be carried in all or a subset of the Beacon frames transmitted by the AP. For example, to reduce the overhead, the indication may be carried only in DTIM Beacons by the AP. In one variant other APs affiliated with the same AP MLD may also carry the indication in their Beacon frames. In another variant, the indication can be carried in a separate group-addressed frame that is transmitted by the AP or other APs of the same AP MLD. This new frame can be a UHR Auxiliary Information frame, and can have an Auxiliary Information Control field indicating presence of one or more different elements. One of them can be the DPS Information element. The presence of such a group addressed frame can be indicated by the AP in the Beacon, for example, in the TIM element or in a new DPS Update field.

To assist unassociated STAs from obtaining the DPS specific information, the AP may also include the DPS information in individually addressed frames sent to unassociated STAs such as Probe Response or Association Response frames. In one variant, the presence of this information in Probe Response or Association Response frame can be indicated using a Presence bit. In a variant, all or some of these parameters, e.g. the indication that the AP is operating in DPS mode, may also be carried in the Reduced Neighbor Report broadcasted by neighboring APs which have the information available. Unassociated STAs and other APs in other BSS can passively obtain the information about the AP's DPS operation by receiving this information from the frames that the AP transmits.

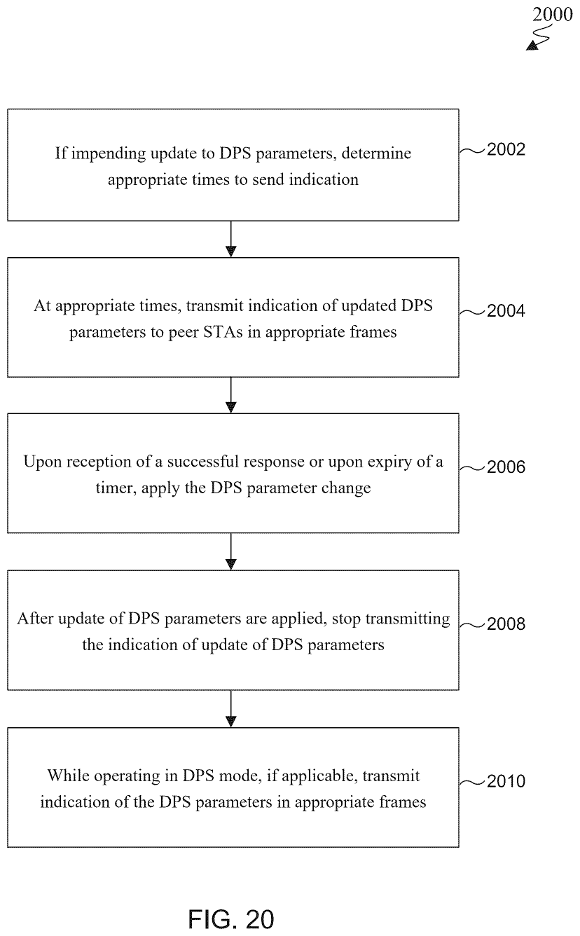

FIG. 20 illustrates an example method 2000 of the operations performed by a DPS STA to indicate DPS parameters according to embodiments of the present disclosure. The embodiment of the method 2000 of the operations performed by a DPS STA to indicate DPS parameters shown in FIG. 20 is for illustration only. Other embodiments of the method 2000 of the operations performed by a DPS STA to indicate DPS parameters could be used without departing from the scope of this disclosure.

As shown in FIG. 20, the method 2000 begins at step 2002, where if there is an impending update to DPS parameters, appropriate times to send the indication are determined. At step 2004, at appropriate times, the indication of updated DPS parameters is transmitted to peer STAs in appropriate frames. At step 2006, upon reception of a successful response or upon expiry of a timer, the DPS parameter change is applied. At step 2008, after the update of DPS parameters is applied, the transmission of the indication of updated DPS parameters is stopped. At step 2010, while operating in the DPS mode, if applicable, the indication of the DPS parameters is transmitted in appropriate frames.

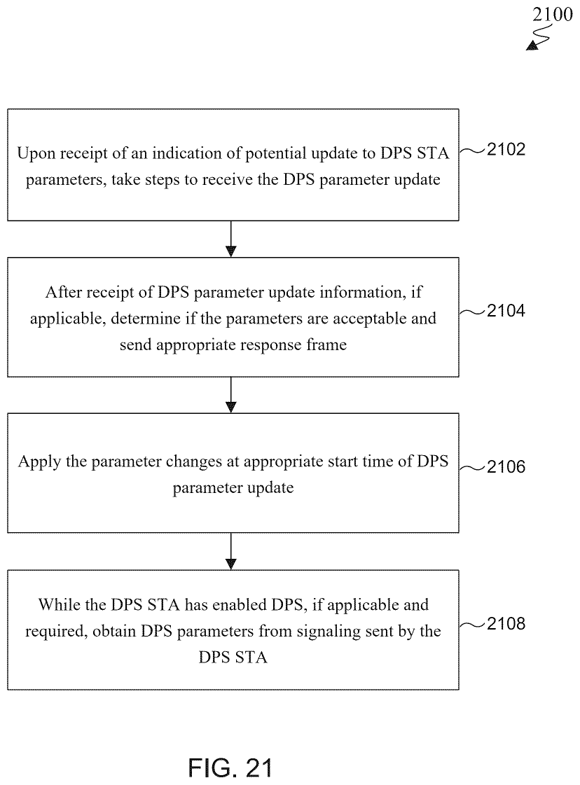

FIG. 21 illustrates an example method 2100 of the operations performed by a DPS supporting peer STA to receive updates about DPS parameters of a DPS STA according to embodiments of the present disclosure. The embodiment of the method 2100 of the operations performed by a DPS supporting peer STA to receive updates about DPS parameters of a DPS STA shown in FIG. 21 is for illustration only. Other embodiments of the method 2100 of the operations performed by a DPS supporting peer STA to receive updates about DPS parameters of a DPS STA could be used without departing from the scope of this disclosure.

As shown in FIG. 21, the method 2100 begins at 2102, where upon receipt of an indication of potential update to DPS STA parameters, steps are taken to receive the DPS parameter update. At step 2104, after receipt of DPS parameter update information, if applicable, a determination is made whether the parameters are acceptable and an appropriate response frame is sent. At step 2106, the parameter changes are applied at the appropriate start time of the DPS parameter update. At step 2108, while the DPS STA has enabled DPS, if applicable and required, DPS parameters are obtained from signaling sent by the DPS STA.

As described herein, in some embodiments the mechanisms described above for enablement/update/disablement of DPS can also be a common framework that is applicable for multiple features defined in 802.11bn or beyond, such as Non-primary Channel Access (NPCA), Dynamic Sub-band Operation (DSO), Dynamic Bandwidth Expansion (DBE), Periodic Unavailability Operation (PUO), Dynamic Unavailability Operation (DUO), Limited Operation Mode (LOM) or the Adaptive Operating Mode (AOM), Coordinated Beamforming (Co-BF), Coordinated Spatial Reuse (Co-SR), Prioritized EDCA (P-EDCA), Low Latency Indication (LLI), etc.

In one embodiment a STA performing an update to any of these features may signal the applicable feature parameters along with an indication of the time when the update takes effect. Here update may include enabling/disabling of the feature or changing one or more of the feature parameters while the feature is enabled etc. This signaling can be included in either broadcast or unicast frames sent by the STA. The indicated information may contain one or more of:
An indication of all the features for which the update is being signaled within the frame. This can, for example, be indicated using a bitmap, or by carrying feature-specific elements or sub-elements within the frame.
A unique identifier to uniquely identify the specific parameter update. This can, for example, be indicated in a Dialog Token field.
For each of the features identified as being part of the update, there may further me signaling of:
   Currently operational feature-specific parameters, if applicable. This can include all or a subset of the parameters being used currently.
   The updated values of feature-specific parameters to be used. This can include all or a subset of the parameters applicable to the feature after the update.
   Indication of start time for the feature parameter update. This indication can be, for example, a counter indicating the expected start time in terms of target beacon transmit times. When included after the update takes effect, this field can be set to 0 or other predetermined value. p2 An indication of the status of the feature/mode after the update takes effect, for e.g., enable/disable, etc.
   Indication of the one or more links for which the update is applicable. For example, there can be a link identifier field indicating the link for which the feature is applicable. In another example, there may be a Per STA Profile sub-element corresponding to each link within the frame, and these indications can be carried within the Per STA Profile sub-element.

In one example all the aforementioned indications can be carried within one element of the transmitted frame. In some variants of this embodiment, some of the aforementioned information, such as the start time indication and/or the indication of the applicable links, may be a common indication that is applicable to all the features being signaled within the frame. Correspondingly, if there are multiple features which are expected to be updated at different times, multiple elements may be included in the transmitted frame. Alternatively, multiple frames may be transmitted by the transmitting STA, each corresponding to a different feature update time. Note that the included parameters above can be dependent on the type of update being performed. For example, when disabling a feature, the Updated parameters may only include a “mode” field that indicates that the feature is being disabled. When a few of the feature parameters are updated, the subset of the parameters which are being updated may be included in the signaling. In another example, only the updated parameters can be included and currently operational feature parameters may be skipped in the signaling. In one embodiment, the indicated information may be dependent on whether the transmitting STA is an AP or a non-AP STA. For example, the indicated start time may not be present in signaling carried by a non-AP STA.

In one embodiment the STA may periodically transmit the indication of feature parameter update while the update is pending. After the parameter update is completed, i.e., a fixed duration after the start time has elapsed the STA may stop transmitting the indication. This may be the case, for example, when the STA is an AP. The standard may indicate the fixed duration or a minimum value corresponding to the fixed duration.

In one embodiment, where the STA is an AP, the aforementioned information can be included by the AP in one or more of Probe Response, Association Response and Beacon frames. In one variant, there can be a subfield to indicate the presence of the Information element/sub-element within these frames that carries the aforementioned feature updates. In another variant, the aforementioned information can be carried in a group-addressed frame transmitted by the AP, and the presence of such a group addressed frame may be indicated within the Beacon, such as within the UHR Operation element or the TIM element. For example, the group addressed frame can be called UHR Auxiliary Information frame, which can have the different feature-specific parameters as subfields/sub-elements, among others. In one example, the UHR Auxiliary Information frame can be a variant of an existing frame such as the Link Reconfiguration Request frame or Link Reconfiguration Response frame.

In one embodiment, when an AP intends to update the aforementioned feature operations, it may signal the corresponding parameters well in advance of the update, so that all associated STAs have sufficient time to have received the indication. For example, the AP may start announcing the update at least a Listen Interval before the Start time of the update. The upcoming change in the feature-specific parameters (determined by inclusion of the parameter update signaling) may be considered a critical update and may cause an increase in one or more of: the BSS Parameter Change Count field, setting of the Critical Update flag, the Check Beacon field etc. As also described previously in this disclosure, in some embodiments, these critical updates may be considered as UHR-specific critical updates which may lead to an update of the UHR BSS Parameter Change Count field and UHR Critical Update Flag instead of their legacy counterparts.

In an embodiment where the STA is a non-AP STA, the aforementioned information can be included by the non-AP STA in one or more of Probe Request and Association Request frames. In a variant, the indication can also be sent in a new Action frame or an existing Action frame transmitted by the non-AP STA to the AP. The new frame can be called, for example the UHR Feature Notification frame or a UHR Operation Mode Notification frame, where there may be a field to indicate the different features being updated. In another variant this frame may be a variant of an existing frame such as the Link Reconfiguration Request frame or Link Reconfiguration Notify frame. In one variant of this embodiment, a start time parameter may not be included and the new feature-specific parameters may come into effect either immediately or a fixed delay after the AP sends an appropriate response frame indicating either acknowledgement or acceptance of the parameters.

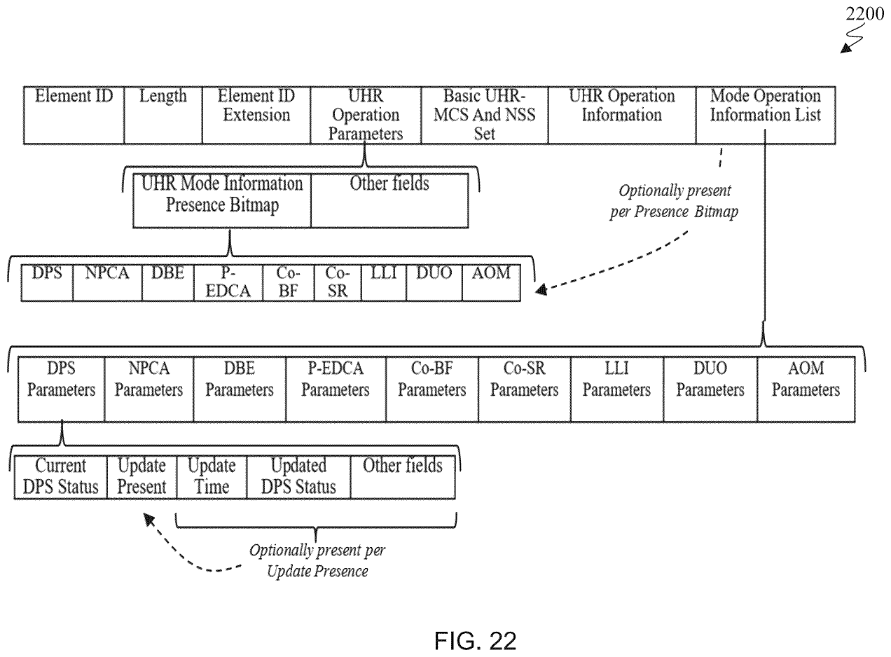

FIGS. 22-25 illustrate several examples of this multi-feature update indication by a STA, where the updates are carried in an element, which can be included in broadcast frames or individually addressed frames. Such a frame can be, for example, the Beacon frames, Probe Response frames and Association Response frames, when the STA is an AP. Such a frame can be, for example, a new Action frame when the STA is a non-AP STA. When the STA is an AP, the updates may be carried in frames such as Beacon, Probe Response and/or Association Response frames or another group-addressed frame, for sufficient time before the update takes effect, and for some predetermined duration after the update takes effect. In a variant the mode or feature parameters may always be carried in Probe Response and Association Response frames while the mode or feature is enabled.

FIG. 22 illustrates an example where parameters of different UHR modes are indicated in the UHR Operations element 2200 according to embodiments of the present disclosure. The embodiment of the example where parameters of different UHR modes are indicated in the UHR Operations element 2200 shown in FIG. 22 is for illustration only. Other embodiments of the example where parameters of different UHR modes are indicated in the UHR Operations element 2200 could be used without departing from the scope of this disclosure.

As shown in FIG. 22, the updates are included in the UHR Operations element, where the element includes a UHR Mode Indication Presence Bitmap field to indicate the UHR modes for which information is carried within the Mode Operation Information List field of the UHR Operations element. The Bitmap may have dedicated bits for different features such as DPS, NPCA, DBE, P-EDCA, Co-BF, Co-SR, LLI, DUO, AOM etc. A bit for a feature may be set to 1 to indicate that Parameters corresponding to that feature are included in the Mode Operation Information List field of the UHR Operations element. The UHR Operations element may also include the Mode Operation Information List field to indicate the parameters corresponding to one or more of the UHR Operation modes. The i-th field of this list field may carry the parameters corresponding to the feature indicated by the i-th bit of the UHR Mode Indication Presence Bitmap that is set to 1. The parameters may be grouped in into a feature-specific Parameters field, e.g., DPS Parameters field for case of DPS. Such a parameters field for each feature may include one or more of:
A Current Status field (enabled/disabled) indicating the current mode status of the feature.
An Update Time field that counts down to the TBTT at which the indicated update takes effect. When included after the update takes effect, this field can be set to 0.
An Updated Status field (enabled/disabled) indicating the mode status after the update time elapses.
Other feature-specific parameters.

In a variant, there may also be an Update Present field to indicate if any feature updates are carried within the Parameters field. Correspondingly the Update Time field, Update Status field and some of the other fields such as the Updated Parameters, may only be present when the Update Present bit is set to 1. In a variant of this example, the Parameters field may also include a Link ID field or Link ID bitmap field to indicate the links for which the parameters are carried within the Parameters field.

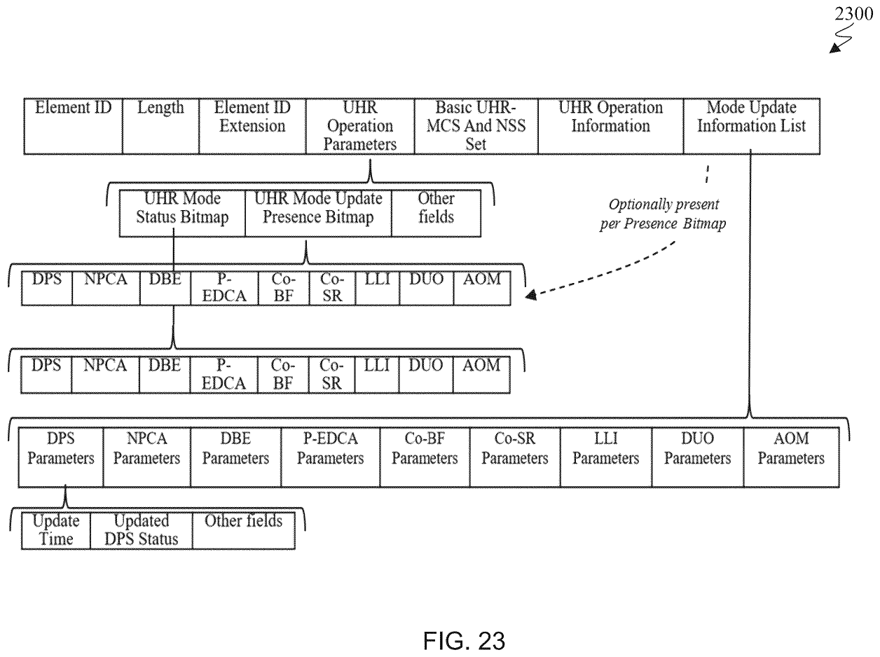

FIG. 23 illustrates another example where parameters of different UHR modes are indicated in the UHR Operations element 2300 according to embodiments of the present disclosure. The embodiment of the example where parameters of different UHR modes are indicated in the UHR Operations element 2300 shown in FIG. 23 is for illustration only. Other embodiments of the example where parameters of different UHR modes are indicated in the UHR Operations element 2300 could be used without departing from the scope of this disclosure.

As shown in FIG. 23, the Current Mode Status is carried within the UHR Operation Parameters field as a UHR Mode Status Bitmap, instead of it being within the feature-specific Parameters field. In this case the UHR Mode Information Presence Bitmap may be replaced with a UHR Mode Update Presence Bitmap, which indicates the UHR modes for which updates are carried within the UHR Operations element. Similarly, the UHR Operation Information List may be replaced by a Mode Update Information List field. The UHR Mode Update Presence Bitmap indicates the features for which updated parameters are carried in the Mode Update Information List field. Note that examples in FIGS. 22 and 23 can be interpreted as extensions of examples described herein to include multiple UHR mode indication.

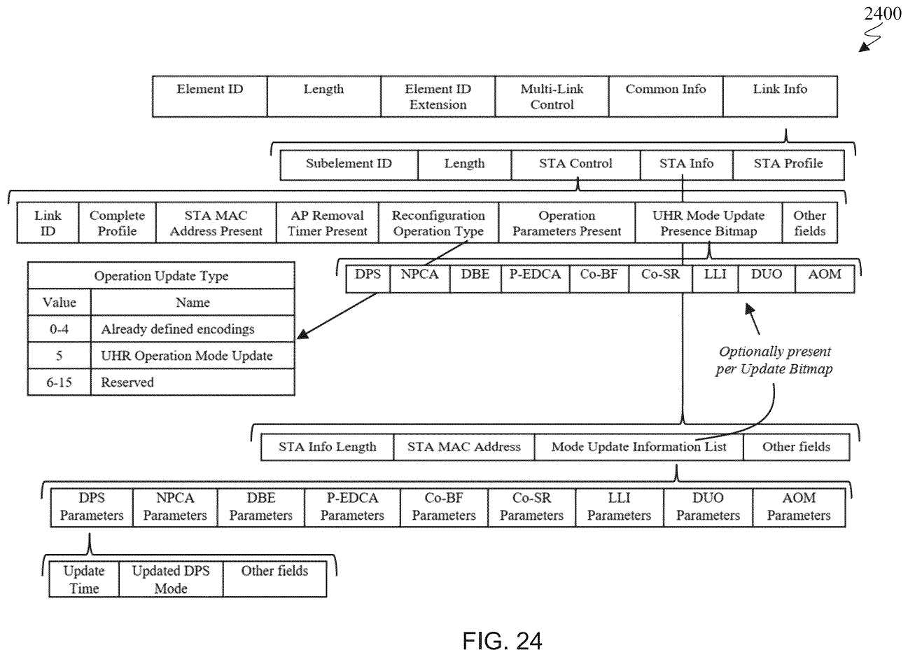

FIG. 24 illustrates an example where parameters of different UHR modes are indicated in the Reconfiguration multi-link element 2400 according to embodiments of the present disclosure. The embodiment of the example where parameters of different UHR modes are indicated in the Reconfiguration multi-link element 2400 shown in FIG. 24 is for illustration only. Other embodiments of the example where parameters of different UHR modes are indicated in the Reconfiguration multi-link element 2400 could be used without departing from the scope of this disclosure.

As shown in FIG. 24, the updates are included in the Reconfiguration Multi-link element, where the updates corresponding to each link may be indicated in the Per-STA Profile sub-element corresponding to that link. The STA Control field of the Per-STA Profile sub-element for a link may include a UHR Mode Update Presence Bitmap field to indicate the UHR modes for which updated information is carried within the Mode Update Information List field of the STA Profile field. The Bitmap may have dedicated bits for different features such as DPS, NPCA, DBE, P-EDCA, Co-BF, Co-SR, LLI, DUO, AOM etc. A bit for a feature may be set to 1 to indicate that updated parameters corresponding to that feature are included in the Mode Update Information List field of the STA Control field. The Per-STA Profile sub-element may also include the Mode Update Information List field in the STA Info field to indicate the updated parameters corresponding to one or more of the UHR Operation modes. The i-th field of this list field may carry the parameters corresponding to the feature indicated by the i-th bit of the UHR Mode Update Presence Bitmap that is set to 1. The parameters may be grouped in into a feature-specific Parameters field, e.g., DPS Parameters field for case of DPS. Such a parameters field for each feature may include one or more of:
An Update Time field that counts down to the TBTT at which the indicated update takes effect. When included after the update takes effect, this field can be set to 0.
An Updated Status field (enabled/disabled) indicating the mode status after the update time elapses.
Other feature-specific parameters.

Note that when this element is transmitted by a non-AP STA to update its mode, some of the fields may be reserved or not present, such has the Update Time field. Some of the feature-specific parameters can also be unique to an AP or a non-AP STA and may not be carried by the other. Note that the examples in FIG. 24 can be interpreted as variants of other examples described herein. As with the example in FIG. 23, the Current Mode Status for each feature for the transmitting link may be carried within the UHR Operation Parameters field of the UHR Operations element, in a UHR Mode Status Bitmap field.

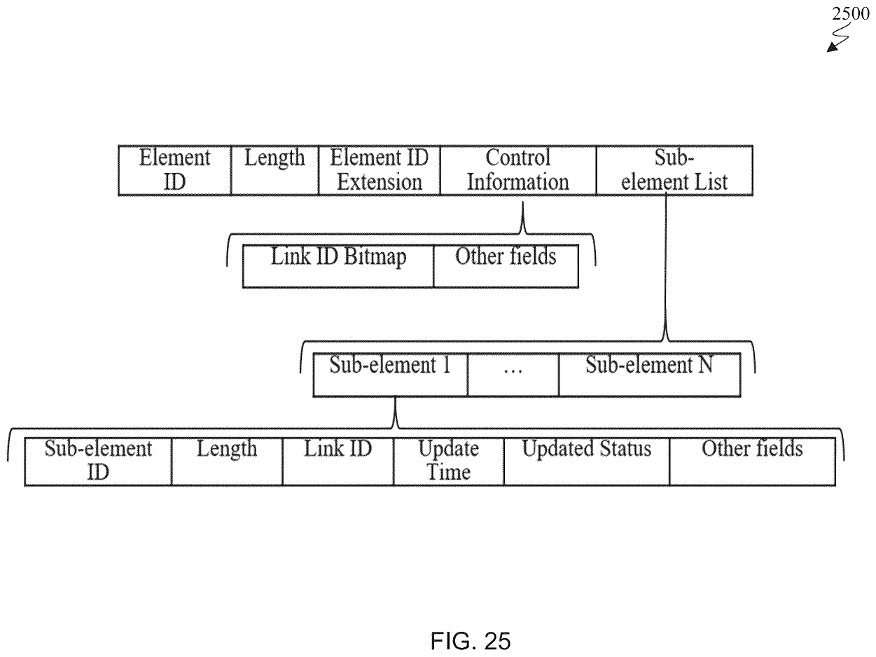

FIG. 25 illustrates still another example where parameters of different UHR modes are indicated in a new element called the UHR Parameters Update element 2500 according to embodiments of the present disclosure. The embodiment of the example where parameters of different UHR modes are indicated in the UHR Parameters Update element 2500 shown in FIG. 25 is for illustration only. Other embodiments of the example where parameters of different UHR modes are indicated in the UHR Parameters Update element 2500 could be used without departing from the scope of this disclosure.

As shown in FIG. 25, the updates are included in a new element which can be optionally carried in Beacon, Probe Response and Association Response frames. The element can be called, for example, the UHR Parameters Update element. The UHR Parameters Update element may include a Control Information field to carry some control information. This Control Information may include one or more of:
A Link ID Bitmap field to indicate the links for which updates are carried within the UHR Parameters Update element.
A Sub-element Count field indicating the number of sub-elements carried within the UHR Parameters Update element.

The UHR Parameters Update element may also carry one or more optional sub-elements, where each UHR mode or feature (e.g., DPS, NPCA, DBE, P-EDCA, Co-BF, Co-SR, LLI, DUO, AOM) may have a dedicated sub-element defined for it with a predetermined sub-element ID assigned. Correspondingly, the UHR Parameters Update element may include one or more sub-element corresponding to each feature for which updates are intended to be indicated by the element. When there are updates for more than one link for a feature, then multiple sub-elements may be included with the same sub-element ID but with different Link ID fields. The sub-element for each feature may include one or more of:
A sub-element ID uniquely identifying the feature for which the updated parameters are carried.
A Link ID field indicating the link for which the updated parameters are carried in the sub-element.
An Update Time field that counts down to the TBTT at which the indicated update takes effect. When included after the update takes effect, this field can be set to 0.
An Updated Status field (enabled/disabled) indicating the mode status after the update time elapses.
Other feature-specific parameters.

Note that when this element is transmitted by a non-AP STA to update its mode, some of the fields may be reserved or not present, such has the Update Time field. Some of the feature-specific parameters can also be unique to an AP or a non-AP STA and may not be carried by the other. As with the example in FIG. 23, the Current Mode Status for each feature for the transmitting link may be carried within the UHR Operation Parameters field of the UHR Operations element, in a UHR Mode Status Bitmap field.

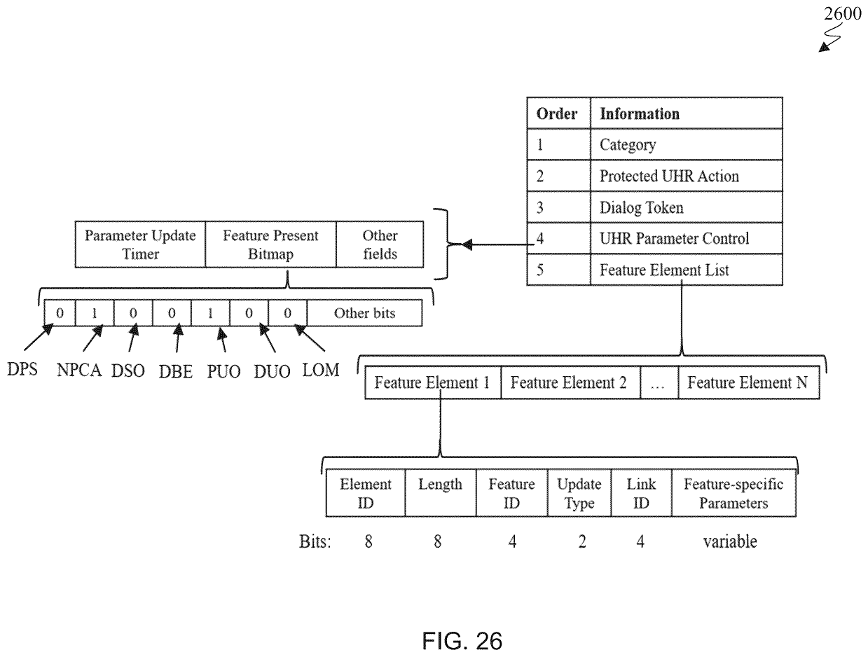

FIG. 26 illustrates an example of UHR feature-specific updates carried in a common frame 2600 according to embodiments of the present disclosure. The embodiment of the example of UHR feature-specific updates carried in a common frame 2600 shown in FIG. 26 is for illustration only. Other embodiments of the example of UHR feature-specific updates carried in a common frame 2600 could be used without departing from the scope of this disclosure.

An example of this multi-feature update indication is depicted in FIG. 26, where the updates are carried in a frame, such as the UHR Operating Mode Notification frame. This frame may include a UHR Parameter Control field, which includes a Parameter Update Timer which indicates when the indications carried in the frame are applicable. The UHR Parameter Control field may also have a Feature Present Bitmap field which identifies the different UHR features for which the updates are carried within the frame. The frame may also include a Feature Element List field that includes one or more Feature elements, each indicating the updates for one of the features indicated as being present in the Feature Present Bitmap. Each feature may have a separate dedicated element having a new Element ID, or there can be a common new element defined for all the features called, for example, UHR Feature Update element. This element may include a Feature ID field to identify the specific feature for which signaling is present in the element, among the multiple features that share the same Element ID. For example, Feature ID 0 for DPS, 1 for NPCA, 2 for DSO, 3 for DBE, and so on. There may be an Update Type field indicating where the element is for enabling/disabling a feature or for updating one or more of the feature parameters. There may also be a Link ID field identifying the link of the transmitting MLD where the feature updates are applicable. The other feature-specific parameters may also be carried within this element. In some variants, the Link ID field may be carried in the UHR Parameter Control field instead of the Feature elements, in which case all the indicated feature updates may be applicable to a common Link ID identified in the UHR Parameter Control field. In another variant, there may be a Link ID Bitmap field instead of the Link ID field in the Feature elements, to indicate that the updated features are applicable to more than one link. In a variant of this example, the Feature Element List field may be a newly defined element, and the different Feature Elements within it may be sub-elements within this element. In some variants, the frame carrying the indication may also include other elements such as the Reconfiguration Multi-link element or other variants of the Multi-link elements. In one example where the transmitting STA is an AP the transmitted frame can be a broadcast frame such as the Beacon frame, Probe Response frame or Association Response frame.

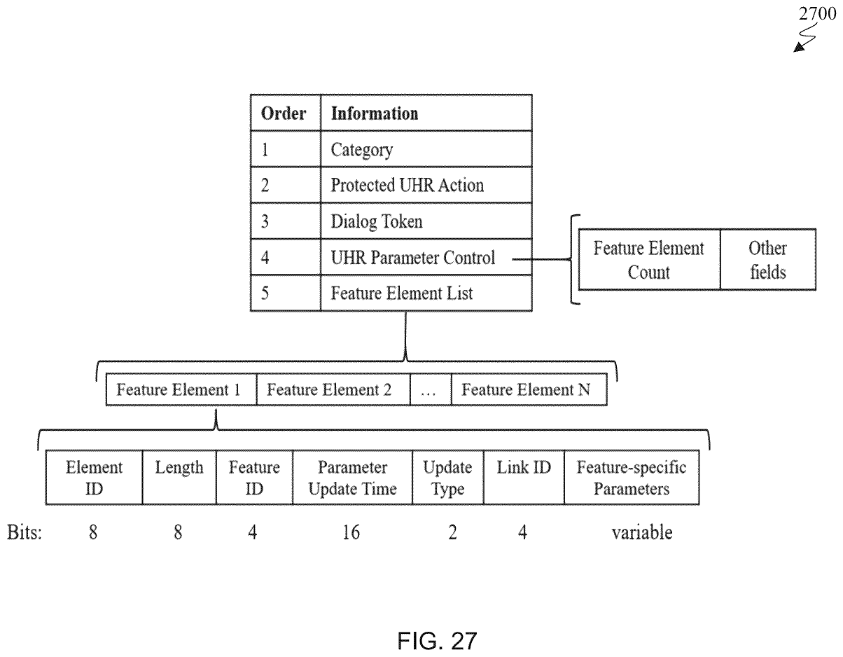

FIG. 27 illustrates another example of UHR feature-specific updates carried in a common frame 2700 according to embodiments of the present disclosure. The embodiment of the example of UHR feature-specific updates carried in a common frame 2700 shown in FIG. 27 is for illustration only. Other embodiments of the example of UHR feature-specific updates carried in a common frame 2700 could be used without departing from the scope of this disclosure.

Another example of this multi-link feature update indication is depicted in FIG. 27, where the updates are carried in a frame, such as the UHR Operating Mode Notification frame. This frame may include a UHR Parameter Control field, which includes a Feature Element Count field to indicate the number of Feature Elements carried in the Feature Element List field. The frame may also include a Feature Element List field that includes one or more Feature elements, each indicating the updates for one of the features. The number of these Feature Elements may be indicated in the Feature Element Count field. Each feature in UHR may have a separate dedicated element having a new Element ID, or there can be a common new element defined for all the features called, for example, UHR Feature Update element. This element may include a Feature ID field to identify the specific feature for which signaling is present in the element, among the multiple features that share the same Element ID. For example, Feature ID 0 for DPS, 1 for NPCA, 2 for DSO, 3 for DBE, and so on. There may be a Parameter Update Time field within the element to indicate the time at which the indicated signaling within the element is applicable. There may be an Update Type field indicating where the element is for enabling/disabling a feature or for updating one or more of the feature parameters. There may also be a Link ID field identifying the link of the transmitting MLD where the feature updates are applicable. The other feature-specific parameters may also be carried within this element. In some variants, the Link ID field may be carried in the UHR Parameter Control field instead of the Feature elements, in which case all the indicated feature updates may be applicable to a common Link ID identified in the UHR Parameter Control field. In another variant, there may be a Link ID Bitmap field instead of the Link ID field in the Feature elements, to indicate that the updated features are applicable to more than one link. In a variant of this example, the Feature Element List field may be a newly defined element, and the different Feature Elements within it may be sub-elements within this element. In some variants, the frame carrying the indication may also include other elements such as the Reconfiguration Multi-link element or other variants of the Multi-link elements. In one example where the transmitting STA is an AP the transmitted frame can be a broadcast frame such as the Beacon frame, Probe Response frame or Association Response frame.

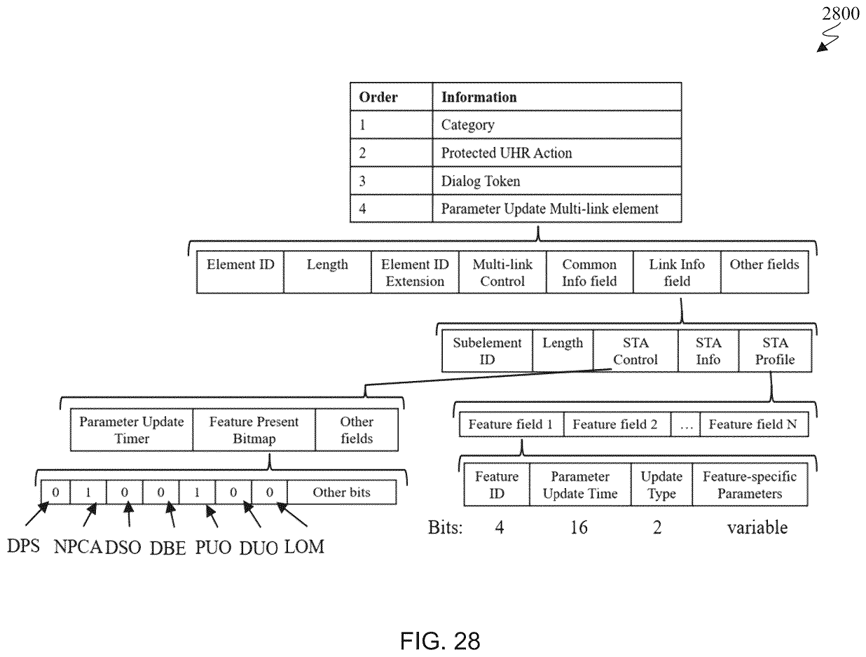

FIG. 28 illustrates yet another example of UHR feature-specific updates carried in a common frame 2800 according to embodiments of the present disclosure. The embodiment of the example of UHR feature-specific updates carried in a common frame 2800 shown in FIG. 28 is for illustration only. Other embodiments of the example of UHR feature-specific updates carried in a common frame 2800 could be used without departing from the scope of this disclosure.

Yet another example of this multi-link feature update indication is depicted in FIG. 28, where the updates are carried in a frame, such as the UHR Operating Mode Notification frame. This frame may include a variant of the Multi-link element called the Parameter Update Multi-link element to carry the updates of the features for one or more links of the transmitting MLD. The Multi-link element can be a new multi-link element or can be a variant of an existing Multi-link element such as the Reconfiguration Multi-link element. The Multi-link element may have one or more per-STA Profile Sub-elements within its Link Info field corresponding to each link associated with the transmitting MLD. The Per-STA Profile sub-element may have a STA Control field, which may contain a Parameter Update Timer field to identify the time corresponding to the feature-specific updates indicated in the Pre-STA Profile sub-element. The STA Control field may also contain a Feature Present Bitmap field which identifies the different UHR features for which the updates are carried within the frame. The Per-STA Profile sub-element may also contain a STA Profile field which includes one or more feature-specific fields, each corresponding to the features identified in the Feature Present Bitmap field. Each feature-specific field may include a Feature ID field to identify the specific feature for which signaling is present in the field. There may be an Update Type field indicating where the field is for enabling/disabling a feature or for updating one or more of the feature parameters. The other feature-specific parameters may also be carried within this field. In some variants of this example the Parameter Update Timer field may be present in the Feature fields instead of in the STA Control field. In some variants, the frame carrying the indication may also include other elements such as the Reconfiguration Multi-link element or other variants of the Multi-link elements. In one example where the transmitting STA is an AP the transmitted frame can be a broadcast frame such as the Beacon frame, Probe Response frame or Association Response frame.

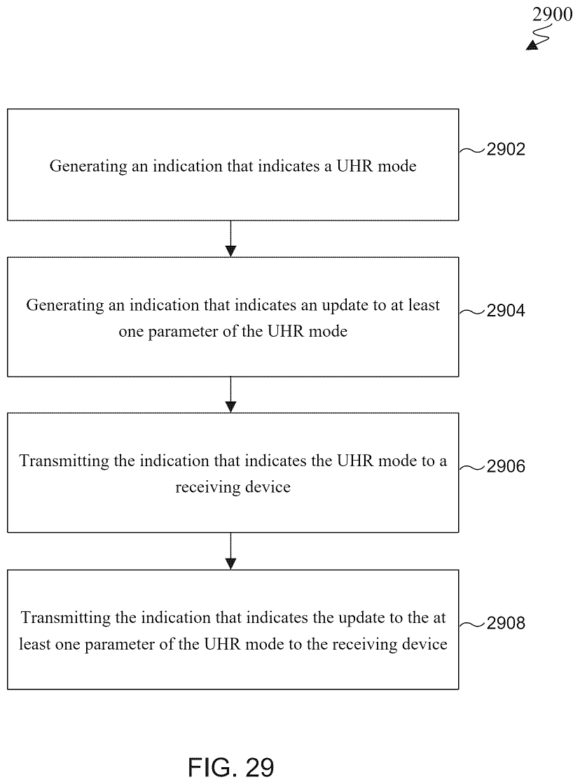

FIG. 29 illustrates a method 2900 performed by an electronic device in a wireless communication system according to embodiments of the present disclosure. The method 2900 of FIG. 29 can be performed by any of the APs 101, 103 of FIG. 1, such as AP 101 of FIG. 2, or by any of the STAs 111-114 of FIG. 1, such as STA 111 of FIG. 3. The method 2900 shown in FIG. 29 is for illustration only. Other embodiments of the method 2900 could be used without departing from the scope of this disclosure.

As illustrated in FIG. 29, the method 2900 begins at step 2902, where the electronic device generates an indication that indicates a UHR mode. For example, the indication may indicate DPS operation, NPCA operation, DSO, DBE, Co-existence support, PUO, DUO, Limited Operation Mode, etc. At step 2904, the electronic device generates an indication that indicates an update to at least one parameter of the UHR mode. At step 2906, the electronic device transmits the indication that indicates the UHR mode to a receiving device. At step 2908, the electronic device transmits the indication that indicates the update to the at least one parameter of the UHR mode to the receiving device.

In some embodiments, the indication that indicates the update to the at least one parameter of the UHR mode comprises at least one of: a UHR mode parameter that indicates whether the UHR mode is enabled or disabled; an indication of a presence of UHR mode information being signaled by the electronic device; an identifier to uniquely identify a specific UHR parameter update; an updated value of the UHR parameter to be used; an indication of a start time for the update of the UHR parameter; and an indication of one or more links for which the update of the UHR parameter is applicable.

In some embodiments, the electronic device transmits the indication that indicates the update to the at least one parameter of the UHR mode while an update to the parameter or an update to another parameter is pending.

In some embodiments, the indication that indicates the update to the at least one parameter of the UHR mode is carried in an element, sub-element, a frame, or a field of a frame.

In some embodiments, the electronic device is an access point (AP) and the receiving device is a non-AP, and the indication that indicates the update to the at least one parameter of the UHR mode is included in at least one of a probe response, an association response, and a beacon frame.

In some embodiments, the electronic device is an access point (AP) and the receiving device is a non-AP, and the electronic device transmits the indication that indicates the update to the at least one parameter of the UHR mode to the receiving device such that the receiving device receives the indication that indicates the update to the at least one parameter of the UHR mode prior to the parameter of the UHR mode being updated.

In some embodiments, the electronic device is a non-access point (non-AP) and the receiving device is an AP, and the electronic device transmits the indication that indicates the update to the at least one parameter of the UHR mode to the receiving device in an action frame.

In some embodiments, the electronic device is a non-AP) and the receiving device is an AP and the electronic device applies the update to the at least one parameter of the UHR mode upon at least one of: reception of a response frame from the receiving device confirming the update to the at least one parameter of the UHR mode; and expiration of a timer from a successful transmission of the indication of the update to the at least one parameter of the UHR mode, wherein the response frame carriers a unique identifier identifying a request frame to which it corresponds, and has a format that corresponds to a frame indicating the update to the at least one parameter of the UHR mode.

In some embodiments, the indication that indicates the update to the at least one parameter of the UHR mode indicates updates to parameters of multiple UHR modes, and the electronic device transmits the indication that indicates the updates to the parameters of multiple UHR modes to the receiving device in a single element of a transmitted frame, where the updates to parameters of multiple UHR modes share some common update parameters and the multiple UHR modes correspond to at least two of: Dynamic Power Save, Non-primary Channel Access, Dynamic sub-band operation, Dynamic bandwidth expansion, Co-existence, Periodic unavailability operation, Dynamic unavailability operation, limited operating mode, Prioritized enhanced distributed channel access, coordinated spatial reuse and coordinated beamforming.

In some embodiments, the electronic device is an AP, the receiving device is a non-AP, and the update to the at least one parameter of the UHR mode corresponds to a non-transmitted BSSID; and the electronic device carries the indication that indicates the update to the at least one parameter of the UHR mode in a Beacon frame corresponding to a transmitted BSSID that is part of the same BSSID set as a BSSID set of the non-transmitted BSSID.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An electronic device comprising:
a transceiver; and
a processor operably coupled to the transceiver, the processor configured to:
generate an indication that indicates an ultra high reliability (UHR) mode; and
generate an indication that indicates an update to at least one parameter of the UHR mode,
wherein the transceiver is configured to:
transmit the indication that indicates the UHR mode to a receiving device; and
transmit the indication that indicates the update to the at least one parameter of the UHR mode to the receiving device.

2. The electronic device of claim 1, wherein the indication that indicates the update to the at least one parameter of the UHR mode comprises at least one of:
a UHR mode parameter that indicates whether the UHR mode is enabled or disabled;
an indication of a presence of UHR mode information being signaled by the electronic device;
an identifier to uniquely identify a specific UHR parameter update;
an updated value of the UHR parameter to be used;
an indication of a start time for the update of the UHR parameter; and
an indication of one or more links for which the update of the UHR parameter is applicable.

3. The electronic device of claim 1, wherein the transceiver is further configured to transmit the indication that indicates the update to the at least one parameter of the UHR mode while an update to the parameter or an update to another parameter is pending.

4. The electronic device of claim 2, wherein the indication that indicates the update to the at least one parameter of the UHR mode is carried in an element, sub-element, a frame, or a field of a frame.

5. The electronic device of claim 2, wherein:
the electronic device is an access point (AP) and the receiving device is a non-AP; and
the indication that indicates the update to the at least one parameter of the UHR mode is included in at least one of a probe response, an association response, and a beacon frame.

6. The electronic device of claim 2, wherein:
the electronic device is an access point (AP) and the receiving device is a non-AP; and
the transceiver is further configured to transmit the indication that indicates the update to the at least one parameter of the UHR mode to the receiving device such that the receiving device receives the indication that indicates the update to the at least one parameter of the UHR mode prior to the parameter of the UHR mode being updated.

7. The electronic device of claim 2, wherein:
the electronic device is a non-access point (non-AP) and the receiving device is an AP; and
the transceiver is further configured to transmit the indication that indicates the update to the at least one parameter of the UHR mode to the receiving device in an action frame.

8. The electronic device of claim 2, wherein:
the electronic device is a non-access point (non-AP) and the receiving device is an AP; and
the transceiver is further configured to apply the update to the at least one parameter of the UHR mode upon at least one of:
reception of a response frame from the receiving device confirming the update to the at least one parameter of the UHR mode; and
expiration of a timer from a successful transmission of the indication of the update to the at least one parameter of the UHR mode,
wherein the response frame carriers a unique identifier identifying a request frame to which it corresponds, and has a format that corresponds to a frame indicating the update to the at least one parameter of the UHR mode.

9. The electronic device of claim 2, wherein:
the indication that indicates the update to the at least one parameter of the UHR mode indicates updates to parameters of multiple UHR modes; and
the transceiver is further configured to transmit the indication that indicates the updates to the parameters of multiple UHR modes to the receiving device in a single element of a transmitted frame, wherein the updates to parameters of multiple UHR modes share some common update parameters and the multiple UHR modes correspond to at least two of: Dynamic Power Save, Non-primary Channel Access, Dynamic sub-band operation, Dynamic bandwidth expansion, Co-existence, Periodic unavailability operation, Dynamic unavailability operation, limited operating mode, Prioritized enhanced distributed channel access, coordinated spatial reuse and coordinated beamforming.

10. The electronic device of claim 2, wherein:
the electronic device is an access point (AP), the receiving device is a non-AP, and the update to the at least one parameter of the UHR mode corresponds to a non-transmitted basic service set identifier (BSSID); and
the transceiver is configured to carry the indication that indicates the update to the at least one parameter of the UHR mode in a Beacon frame corresponding to a transmitted BSSID that is part of the same BSSID set as a BSSID set of the non-transmitted BSSID.

11. A method performed by an electronic device, the method comprising:
generating an indication that indicates an ultra high reliability (UHR) mode;
generating an indication that indicates an update to at least one parameter of the UHR mode;
transmitting the indication that indicates the UHR mode to a receiving device; and
transmitting the indication that indicates the update to the at least one parameter of the UHR mode to the receiving device.

12. The method of claim 11, wherein the indication that indicates the update to the at least one parameter of the UHR mode comprises at least one of:
a UHR mode parameter that indicates whether the UHR mode is enabled or disabled;
an indication of a presence of UHR mode information being signaled by the electronic device;
an identifier to uniquely identify a specific UHR parameter update;
an updated value of the UHR parameter to be used;
an indication of a start time for the update of the UHR parameter; and
an indication of one or more links for which the update of the UHR parameter is applicable.

13. The method of claim 11, further comprising transmitting the indication that indicates the update to the at least one parameter of the UHR mode while an update to the parameter or an update to another parameter is pending.

14. The method of claim 12, further comprising carrying the indication that indicates the update to the at least one parameter of the UHR mode in an element, sub-element, a frame, or a field of a frame.

15. The method of claim 12, wherein:
the electronic device is an access point (AP) and the receiving device is a non-AP; and
the indication that indicates the update to the at least one parameter of the UHR mode is included in at least one of a probe response, an association response, and a beacon frame.

16. The method of claim 12, wherein:
the electronic device is an access point (AP) and the receiving device is a non-AP; and
the method further comprises transmitting the indication that indicates the update to the at least one parameter of the UHR mode to the receiving device such that the receiving device receives the indication that indicates the update to the at least one parameter of the UHR mode prior to the parameter of the UHR mode being updated.

17. The method of claim 12, wherein:
the electronic device is a non-access point (non-AP) and the receiving device is an AP; and
the method further comprises transmitting the indication that indicates the update to the at least one parameter of the UHR mode to the receiving device in an action frame.

18. The method of claim 12, wherein:
the electronic device is a non-access point (non-AP) and the receiving device is an AP; and
the method further comprises applying the update to the at least one parameter of the UHR mode upon at least one of:
reception of a response frame from the receiving device confirming the update to the at least one parameter of the UHR mode; and
expiration of a timer from a successful transmission of the indication of the update to the at least one parameter of the UHR mode,
wherein the response frame carriers a unique identifier identifying a request frame to which it corresponds, and has a format that corresponds to a frame indicating the update to the at least one parameter of the UHR mode.

19. The method of claim 12, wherein:
the indication that indicates the update to the at least one parameter of the UHR mode indicates updates to parameters of multiple UHR modes; and
the method further comprises transmitting the indication that indicates the updates to the parameters of multiple UHR modes to the receiving device in a single element of a transmitted frame, wherein the updates to parameters of multiple UHR modes share some common update parameters and the multiple UHR modes correspond to at least two of: Dynamic Power Save, Non-primary Channel Access, Dynamic sub-band operation, Dynamic bandwidth expansion, Co-existence, Periodic unavailability operation, Dynamic unavailability operation, limited operating mode, Prioritized enhanced distributed channel access, coordinated spatial reuse and coordinated beamforming.

20. The method of claim 12, wherein:
the electronic device is an access point (AP), the receiving device is a non-AP, and the update to the at least one parameter of the UHR mode corresponds to a non-transmitted basic service set identifier (BSSID); and
the method further comprises carrying the indication that indicates the update to the at least one parameter of the UHR mode in a Beacon frame corresponding to a transmitted BSSID that is part of the same BSSID set as a BSSID set of the non-transmitted BSSID.
